(19) United States
(12) Patent Application Publication
(10) Pub. No.: US 2026/0314601 A1
(43) Pub. Date: Oct. 15, 2026

(54) LIQUID FOSETYL-ALUMINIUM FORMULATIONS

(71) Applicant: Discovery Purchaser Corporation, Wilmington, DE (US)

(72) Inventors: Arnoldus VERMEER, Monheim (DE); Jens KRAUSE, Leverkusen (DE); Monika BALLMANN, Hurth (DE); Martin STEINBECK, Koln (DE); Andreas IDE, Langenfeld (DE)

(73) Assignee: Discovery Purchaser Corporation, Wilmington, DE (US)

(21) Appl. No.: 19/551,987

(22) Filed: Feb. 27, 2026

Related U.S. Application Data
(63) Continuation of application No. PCT/EP2024/078632, filed on Oct. 11, 2024.

(30) Foreign Application Priority Data
Oct. 20, 2023 (EP) 23204893.4

(51) Int. Cl. A01N 57/12; A01N 25/04; A01N 25/22; A01N 25/30; A01N 61/00; A01P 3/00; A01P 21/00

(52) U.S. Cl. CPC A01N 57/12; A01N 25/04; A01N 25/22; A01N 25/30; A01N 61/00; A01P 3/00; A01P 21/00

(57) ABSTRACT

The invention relates to a liquid non-aqueous composition of fosetyl-aluminium or fosetyl-sodium comprising the active ingredient in an amount of 20 to 60 wt %. The invention further relates to a process for production thereof and to the use thereof for application of the active ingredients present.

### CROSS REFERENCE TO RELATED APPLICATIONS

This application is a continuation of International Patent Application No. PCT/EP2024/078632 having an international filing date of Oct. 11, 2024, which claims the benefit of European Patent Application No. 23204893.4 filed Oct. 20, 2023, each incorporated herein by reference in their entireties.

The invention relates to a liquid non-aqueous composition of fosetyl-aluminium or fosetyl-sodium comprising the active ingredient in an amount of 20 to 60 wt %. The invention further relates to a process for production thereof and to the use thereof for application of the active ingredients present.

It is known that active ingredients differ from one another in aspects including their physicochemical properties, for example solubility in water, solvents and/or oils, melting and boiling point, polarity, molar mass, etc. These properties affect the ability to formulate the active ingredients as well as the properties of the resultant formulations and their suitability for particular agrochemical or turfgrass/ornamental management applications.

It is additionally known that organic substances have different water solubilities, and these water solubilities, according to chemical characteristics, may be pH-dependent, for example through salt formation.

Fosetyl-aluminium is a solid active ingredient that has so far only been formulated in solid formulations such as water dispersible granules (WG) or wettable powders (WP). Fosetyl-aluminium has a very high water solubility (111.3 g/L at 20° C.) and once dissolved in water becomes unstable after several days. Therefore, fosetyl-aluminium cannot be formulated as a stable suspension concentrate (SC) formulation in water. Unfortunately, fosetyl-aluminium has also a very poor solubility in most organic solvents and thus cannot be formulated as an emulsifiable concentrate (EC). Another drawback for the formulation is the relatively high amount needed of fosetyl-aluminium to have good efficacy in agrochemical applications. Very often rates higher than 1000 g/ha have to be applied. Thus the concentration in the concentrate needs preferably to be formulated higher than 400 g/L. At lower concentrations the application rate for the farmer would be too high. This is one reason why solid formulations of up to 80 wt % have become so popular (e.g. under the brand Aliette from Bayer AG). However, farmers prefer liquid formulations as they can be easier used (e. g. the dosing in volume is easier than the dosing of a solid formulations where a balance must be used) and liquid formulations are not dusty.

Typical oil dispersions (OD) as described for example in EP2193712 are also not suitable for liquid fosetly-aluminium concentrates. As oils very often result in very high viscosities of the formulations, concentrations with typical oils such as mineralic oil or rapeseed oil cannot exceed loadings higher than 300 g/L.

A further challenge is the very low pH value of fosetyl-aluminium (around pH 3-4 measured in an aqueous spray solution). Thus the dispersant must disperse fosetyl-aluminium at very low pH values and must further increase the solubilization behaviour of the active ingredient in the spray solution before it settles down and solidifies.

Therefore, the applicant has recognized a need for non-solid, water free dispersions of fosetyl-aluminium, that preferably provide a high loading of active ingredient, without having a negative effect on the stability of the active ingredient. Additionally, the formulations must be characterized by good long-term stability and must have a good dispersibility in the spray solution applied by the farmer or end-user.

The formulation of pesticidal active ingredients, which are only partly insoluble in water or are chemically unstable upon long term exposure to water was already discussed in U.S. Pat. No. 4,348,385.

US2008/318774 describes stable agrochemical suspensions comprising 60 to 90 wt % glycerine and mentions that inter alia fosetyl-aluminium can be used in this suspension. However, due to the high concentration of glycerine, the described formulations are not suitable for formulations having a high load of fosetyl-aluminium as the viscosity would be much too high for any commercial use. In US2008/318774 the maximum load of active ingredient is therefore described to be 30 wt %.

U.S. Pat. No. 5,906,962 describes stable non-aqueous suspensions comprising 5 to 85 wt % of active ingredient which could be inter alia fosetyl-aluminium. However, stable formulations can only be obtained when using hydratable polysaccharides, such as xanthan gum or hydroxypropyl ether guar gum as thickener. In case of fosetyl-aluminium or fosetyl-sodium the use of these thickeners leads to a commercially unacceptable increase in the viscosity of the formulation.

WO03/006135 describes stable non-aqueous suspensions comprising 0.1 to 75 wt % of solid particles which could be inter alia fosetyl-aluminium. However, stable formulations can only be obtained when using hydrogenated castor oil or wax and in most cases also in combination with silica. Hydrogenated castor oil or wax is known to have a thickening influence on formulations.

In the case of fosetyl-aluminium or fosetyl-sodium the use of these thickeners leads to a commercially unacceptable increase in the viscosity of the formulation.

US2002/065198 discloses stable suspensions concentrates comprising one or more agricultural solids, a single non-ionic surfactant and a water-soluble liquid. However, this document provides no disclosure of formulations containing fosetyl-aluminium.

US2018/228161 describes aqueous suspensions comprising a solubilized phosphite salt, which could be according to the description also fosetyl-aluminium. US2018/228161 discloses no examples which use fosetyl-aluminium and also mentions the preference of disodium hydrogen phosphite. The aqueous conditions mentioned in US2018/228161 would lead to hydrolysis of fosetyl-aluminium and are hence not suitable for this active ingredient.

US2008/280763 discloses a method for improving turfgrass quality using an aqueous composition based on fosetyl-aluminium and a phthalocyanine compound.

WO 2017/025581 and WO2017/025582 describe agrochemical formulations, which should overcome the draw backs of aqueous suspension formulations, e.g. not suitability for active ingredients, which have a high water solubility. Both patent applications describe liquid non-aqueous compositions comprising a pesticide in the form of suspended particles, a water soluble solvent, alkoxylates and fumed silica particles as an inorganic thickener. Both patents do not specifically mention aluminium complexes such as fosetyl-aluminium that have very high water solubility. Additionally, the achieved loading of the disclosed formulations is rather low. Further WO2017/025582 shows that physically stable formulations can only be obtained using the fumed silica particles as inorganic thickener. However, in case of fosetyl-aluminium or fosetyl-sodium the use of these thickeners leads to a commercially unacceptable increase in the viscosity of the formulation.

The problem of the present invention was therefore to provide a long term stable liquid formulation of fosetyl-aluminium or fosetyl-sodium with a high loading of active ingredient and a commercially acceptable viscosity.

This problem was surprisingly solved according to certain embodiments of the invention by a liquid non-aqueous composition comprising
a) fosetyl-aluminium or fosetyl-sodium,
b) a water soluble solvent,
c) a surfactant and
d) an organic or inorganic colorant,
wherein compound a) is present in an amount of 20 to 60 wt % and the composition comprises no organic or inorganic thickener.

It was surprisingly found, that liquid compositions with a high loading of fosetyl complexes, which contain organic or inorganic colorants show an improved long term stability compared to those without colorants.

The liquid compositions can further be obtained without the addition of any thickeners.

The presently disclosed compositions may therefore contain no inorganic or organic thickeners. According to certain aspects of the present disclosure, the presently disclosed fosetyl-aluminium or fosetyl-sodium compositions specifically exclude an inorganic thickener and/or an organic thickener.

It is a feature of stable liquid compositions that they are both physically and chemically storage-stable over a prolonged period (at least 12 to 24 months) and over a wide temperature range (0 to 54° C.). This broad temperature range is required in order that, advantageously, just a single formulation with the same active ingredients or active ingredient combinations can be used in different climatic regions.

The storage stability of liquid compositions is characterized in that, inter alia, containers of these liquid compositions have only low phase separation, if any, over the period of storage. A further parameter for the stability of liquid compositions is, for example, the stability of the dispersion in the composition, which is manifested in the presence or absence of agglomerates in the composition.

Compositions as described in the present application that consist solely of the essential components (not optional components) should likewise be considered to be disclosed.

Moreover, in ranges of preference stated in the present invention, the different levels of preference should be understood such that they can be combined with one another in permutations, but in any case identical levels of preference and especially the most preferred embodiment/level of preference in each case are to be combined with one another and are indeed disclosed as such a combination.

Room temperature in the context of the present invention means, unless stated otherwise, a temperature of 20° C. to 25° C.

If not otherwise indicated, % and wt % in this application means percentage by weight. The mentioned percentage values are based on the total weight of the composition.

It is understood that in case of combinations of various components, the percentages by weight of all components of the composition sum up to 100.

In the context of the present invention, unless defined differently elsewhere, the term “alkyl”, either on its own or else in combination with further terms, is understood to mean a radical of a saturated, aliphatic hydrocarbon group which has preferably 1 to 18 carbon atoms and may be branched or unbranched. Non-limiting examples of alkyl radicals may include methyl, ethyl, n-propyl, isopropyl, n-butyl, isobutyl, sec-butyl and tert-butyl.

Fosetyl-aluminium is a fungicidal active compound with the chemical name aluminium-tris (ethylphosphonate), the CAS-number 39148-24-8 and a solubility in water of 111.3 g/L at 20° C.

Fosetyl-sodium is a fungicidal active compound with the chemical name sodium-tris (ethylphosphonate), the CAS-number 39148-16-8 and a solubility in water of 770 g/L at 20° C.

Compound a) in the composition according to the invention is selected from fosetyl-aluminium and/or fosetyl-sodium, preferably compound a) is fosetyl-aluminium.

Compound a) is present in the composition according to the invention in an amount of 20 to 60 wt %, preferably 35 to 55 wt %, more preferably 36 to 49 wt % and most preferred from 38 to 48 wt %, based on the total weight of the composition.

The composition is a liquid composition, which may be liquid at room temperature. The composition usually comprises a continuous liquid phase and a suspended solid phase. The liquid phase usually comprises the water soluble solvent. The solid phase is usually formed by solid particles within the liquid phase. The solid phase usually comprises the pesticide particles.

The composition is a non-aqueous composition. The composition usually comprises less than 5 wt %, preferably less than 2 wt %, and in particular less than 1 wt % of water. In another form the composition is essentially free of water.

Preferably compound a) is present in the composition in the form of suspended particles.

The particle size distribution D90 of compound a) as used in the composition is preferably from 10 to 40 μm, more preferably from 15 to 30 μm and most preferred from 16 to 25 μm.

The particle size distribution D90 of compound a) as present in the composition is preferably from 10 to 40 μm, more preferably from 14 to 30 μm and most preferred from 15 to 25 μm.

The particle size distribution D90 of the suspended particles in the composition is preferably from to 40 μm, more preferably from 14 to 30 μm and most preferred from 15 to 25 μm.

The particle size distribution D90 of the particles in the composition may also have an influence on the long term stability of the composition.

The particle size distribution is determined according to CIPAC (CIPAC=Collaborative International Pesticides Analytical Council; (www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Analytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. The D90 value gives the active ingredient particle size of 90% of all volume particles.

The active ingredient compound a) can be initially used as micronized active ingredient or can be micronized via for example jet or bead milling during the preparation of the composition.

Compound a) may be present in the form of crystalline or amorphous particles which are solid at temperatures below 60° C.

The composition according to the present disclosure further comprises compound b), a water soluble solvent.

In a special embodiment the composition of the present disclosure further comprises compound b), one or more water soluble solvents.

Preferably the composition comprises a mixture of at least two water soluble solvents.

The water soluble solvents may have a solubility in water at 20° C. of at least 25 g/L, preferably of at least 50 g/L ° C., more preferably at least 100 g/L and in particular of at least 200 g/L.

The water soluble solvents are preferably selected from the alcohols or ethers according to formula (I),

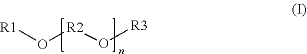

wherein
R¹ and R³ are independently of each other selected from H or (C₁-C₄)alkyl,
R² is selected from (C₂-C₄)alkyl and
n is 1 to 5, preferably n is 1 to 2,
further from propylene carbonate, dipropylene carbonate, butylene carbonate, dibutylene carbonate, glycerine or mixtures thereof.

More preferably the water soluble solvents are selected from propylene glycol, dipropylene glycol, ethylene glycol, diethylene glycol, propylene carbonate, dipropylene carbonate, butylene carbonate, glycerine, polyethylene glycol, polypropylene glycol, dipropylene glycol methyl ether, propylene glycol methyl ether, tripropylene glycol methyl ether, propylene glycol n-propyl ether, diethylene glycol methyl ether, triethylene glycol methyl ether, diethylene glycol ethyl ether, triethylene glycol ethyl ether, ethylene glycol propyl ether, ethylene glycol n-butyl ether, diethylene glycol n-butyl ether, triethylene glycol n-butyl ether or mixtures thereof.

Even more preferably the water soluble solvents are selected from glycerine, propylene glycol methyl ether, dipropylene glycol methyl ether, tripropylene glycol methyl ether or mixtures thereof.

In the context of the present invention (especially for R¹, R² and R³) the (C₃-C₄)alkyl groups include all possible structural isomers.

The propylene glycol may be 1,2-propylene glycol or 1,3-propylene glycol. Preferably, the propylene glycol is 1,2-propylene glycol.

The composition may comprise at least 20 wt %, preferably at least 25 wt %, and in particular at least 30 wt % of water soluble solvents b). In another form the composition may comprise from 20 to 79.5 wt %, preferably from 25 to 64.5 wt %, and in particular from 30 to 63.5 wt % of water soluble solvents b). In another form the water soluble solvent(s) b) are added in an amount to fill up the composition to 100 wt %.

In case the water soluble solvent b) is glycerine or contains glycerine, the composition comprises less than 30 wt % of glycerine, preferably less than 20 wt % of glycerine.

The composition may comprise further organic solvents in addition to the water soluble solvent.

Suitable further organic solvents are mineral oil fractions of medium to high boiling point, e.g. kerosene, diesel oil; oils of vegetable or animal origin; aliphatic, cyclic and aromatic hydrocarbons, e. g. toluene, paraffin, tetrahydronaphthalene, alkylated naphthalenes; alcohols, e.g. benzylalcohol, cyclohexanol; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides; and mixtures thereof. The composition may comprise up to 10 wt %, preferably up to 3 wt %, and in particular up to 1 wt % of the further organic solvents. In one form the composition is essentially free of the further organic solvent. Typically, the further organic solvent is a water-insoluble organic solvent. In at least some embodiments, the presently disclosed compositions may include up to 10 wt % water-insoluble organic solvent. In other embodiments, the presently disclosed compositions may include up to 3 wt % or up to 1 wt % water-insoluble organic solvent. In certain embodiments, the presently disclosed compositions may be substantially free of a water-insoluble organic solvent. In some embodiments, the presently disclosed compositions may be substantially free of a further water-insoluble organic solvent other than the recited components.

The composition according to the invention further comprises an organic or inorganic colorant d) which can be selected from all substances typically usable for this purpose in agrochemical compositions.

In a special embodiment the composition of the present disclosure further comprises compound d), one or more colorants.

Non-limiting examples of suitable colorants may include white, red, blue, or green pigments or dyes, preferably green dyes or pigments. In certain embodiments, the pigments may be low water solubility pigments and the dyes may be water-soluble dyes.

The colorants according to the invention are preferably selected from inorganic or organic pigments or dyes. More preferably the colorants absorb light in the range between 280 and 2500 nm.

Preferred colorants may be selected from iron oxide, titanium oxide, Prussian Blue, carbon black, zinc oxide, iron hexacyanoferrate, naphthol AS-based colorants, anthraquinone-, azo-, pyrrole- and metal phthalocyanine colorants, and combinations thereof.

More preferably the colorants may be selected from anthraquinone-, pyrrole- and metal phthalocyanine colorants, naphthol AS-based colorants, and combinations thereof.

Even more preferably the colorants may be selected from metal-phthalocyanine, diketo pyrrolo pyrrole or water soluble anthraquinone colorants, naphthol AS-based colorants, and combinations thereof.

The composition may comprise up to 15 wt %, preferably up to 10 wt %, and in particular up to 5 wt % of colorant d). The composition may comprise from 0.1 to 15 wt %, preferably from 0.5 to 10 wt %, and in particular from 1 to 5 wt % of colorant d).

The addition of the colorants leads to an improved long term stability of the formulation.

The composition according to the invention further comprises compound c), a surfactant.

In a special embodiment the composition of the present disclosure further comprises compound c), one or more surfactants.

Surfactants include generally all surface active substances which are commonly used in formulations of active agrochemical ingredients.

The surfactants according to the invention are preferably selected from anionic and/or non-ionic surfactants.

The surfactants may in the composition according to the invention have different functions. They can act for example as emulsifiers, wetting agents or dispersants.

Anionic surfactants are preferably selected from alkali metal, alkaline earth metal or ammonium salts of sulfonates, sulfates, phosphates or carboxylates and mixtures thereof.

Especially preferred are
salts of polyacrylic acid,
salts of polymers of mixtures of acrylic acid/acrylate esters,
salts of polymers of mixtures of acrylic acid/styrene,
salts of lignosulfonic acid (such as sodium lignosulfonate),
salts of phenolsulfonic acid,
salts of condensation products of phenolsulfonic acid and formaldehyde, salts of naphthalenesulfonic acid or alkyl naphthalenesulfonic acid,
salts of naphthalenesulfonic acid or alkyl naphthalenesulfonic acid and formaldehyde condensation products thereof,
salts of sulfonates of condensed naphtalenes or alkyl napthtalenes,
salts of sulfonates of dodecyl- and tridecylbenzenes,
salts of sulfosuccinic or sulfosuccinamate esters,
salts of alkyl sulfates,
salts of alkyl polyethoxylated and/or polypropoxylated sulfates,
salts of paraffin sulfonates,
salts of alkyl sulfonates,
salts of alkyl polyethoxylated and/or polypropoxylated sulfonates,
salts of aryl sulfates,
salts of aryl polyethoxylated and/or polypropoxylated sulfates,
salts of aryl sulfonates,
salts of aryl polyethoxylated and/or polypropoxylated sulfonates,
salts of alkylaryl sulfates,
salts of alkylaryl polyethoxylated and/or polypropoxylated sulfates,
salts of alkylaryl sulfonates,
salts of alkylaryl polyethoxylated and/or polypropoxylated sulfonates,
salts of diphenyl sulfonates, and of diphenyloxide sulfonates,
salts of alpha-olefinsulfonates,
salts of sulfonates of fatty acids and oils,
salts of alpha-sulfonated methyl esters,
salts of taurine derivatives (preferably alkyl taurates),
salts of isethionates,
salts of alkyl phosphoric esters,
salts of aryl phosphoric esters,
salts of alkylaryl phosphoric esters,
salts of phosphoric esters of polyethoxylated and/or polypropoxylated aliphatic linear or branched alcohols,
salts of phosphoric esters of polyethoxylated and/or polypropoxylated aryl alcohols,
protein hydrolysates,
lignosulfite waste liquors,
salts of polystyrenesulphonic acids,
salts of polyvinylsulphonic acids,
salts of alkyl carboxylates,
salts of alkylaryl carboxylates,
salts of aryl carboxylates or
salts of ether carboxylates.

Any reference to salts in this paragraph refers preferably to the respective alkali, alkaline earth and ammonium salts.

Examples of anionic surfactants from the group of salts of aryl sulfonates are calcium dodecylbenzenesulfonate such as Rhodocal® 70/B (Solvay), Phenylsulfonat CA100 (Clariant), Calsogen® AR 100, Rhodacal® 60BE, KEMMAT® HF 60, CALSOGEN® 4814, NANSA® EVM 70/2E or isopropylammonium dodecylbenzenesulfonates such as Atlox® 3300B (Croda).

Examples of anionic surfactants from the group of the naphthalenesulfonates are Galoryl® MT 800 (sodium dibutylnaphthalenesulfonate), Morwet® IP (sodium diisopropylnaphthalenesulfonate), Morwet® B (Sodium alkylnaphtalene sulfonate), Morwet® DB (Alkylnaphtalene sulfonate, sodium salt), Morwet® EFW (Alkylnaphtalinsulfonate sodium salt mixture) and Nekal® BX (alkylnaphthalenesulfonate). Examples of anionic surfactants from the group of the condensates of (alkyl) naphthalenesulfonates with formaldehyde are Galoryl® DT 201 (naphthalenesulfonic acid hydroxy polymer with formaldehyde and methylphenol sodium salt), Galoryl® DT 250 (condensate of phenol- and naphthalenesulfonates), Baykanol® SL (Formaldehyde, reaction products with sulfonated 1,1′-oxybis[methylbenzene], sodium salts), Reserve® C (condensate of phenol- and naphthalenesulfonates) or Morwet® D-425, Tersperse® 2020.

Examples of anionic surfactants from the group of the aryl polyethoxylated and/or polypropoxylated sulfates, especially ethoxylated polyarylphenol sulfates are Soprophor® 4D384, Lucramul® SPS 16, STEOL® TSP-16N, Surfom® SC 8384, Tersperse® 2218, Soprophor® 3D33, Soprophor® CY/8 (Solvay) and Hoe® S3474, and in the form of the Sapogenat® T products (Clariant), for example Sapogenat® T 100.

Further preference is given to alkali, alkaline earth and ammonium salts of
arylsulfonates, especially dodecylbenzenesulfonates,
aryl polyethoxylated and/or polypropoxylated sulfates, especially polyethoxylated and/or polypropoxylated polyarylphenol sulfates,
naphthalenesulfonic acid or alkyl naphtalenesulfonic acid,
formaldehyde condensation products of naphthalenesulfonic acid or alkyl naphtalenesulfonic acid or
sulfonates of condensed naphtalenes or alkyl napthtalenes.

Particular preference is given to the sulfonates of condensed naphtalenes or alkyl napthtalenes, especially the sodium salt of naphthalene or alkyl naphthalene sulfonate condensates with formaldehyde, in particular Morwet® D-425.

Non-ionic surfactants are preferably selected from
polycondensates of ethylene oxide and/or propylene oxide,
polycondensates of ethylene oxide and/or propylene oxide with fatty alcohols,
polycondensates of ethylene oxide and/or propylene oxide with fatty acids or fatty acid alcohols,
polycondensates of ethylene oxide and/or propylene oxide with phenols or substituted phenols,
polycondensates of ethylene oxide and/or propylene oxide with fatty amines,
polyoxyethylene fatty acid esters,
polyoxyethylene fatty alcohol ethers,
fatty esters of polyols and ethoxylates thereof,
fatty esters of alkanolamides,
polyvinyl alcohol,
polyvinylpyrrolidone,
copolymers of polyvinyl alcohol and polyvinylpyrrolidone,
copolymers of (meth)acrylic acid and (meth)acrylic acid esters,
polyoxyalkylenamines,
polyoxyethylene alkanediol,
polyoxyethlyene and/or polyoxypropylene alkyne diols,
copolymer of vinyl chloride and vinyl acetate and partially hydrolyzed vinyl acetate.

The polycondensates of ethylene oxide and/or propylene oxide have preferably weight-average molecular weights Mw between 200 and 10 000 and preferably 1000 to 4000 g/mol.

If not otherwise defined in this application, the molecular weight of polymers refers to the weight-average molecular weight Mw, which is determined by GPC in methylene chloride at 25° C. with polystyrene as the standard or by GPC in water at 25° C. with polyethyleneoxide as the standard.

The polycondensates of ethylene oxide and/or propylene oxide with alcohols are preferably selected from:
polyethylene glycol ethers of branched or linear, saturated or unsaturated alcohols,
polypropylene glycol ethers of branched or linear, saturated or unsaturated alcohols,
polycondensates of polyethylene and polypropylene glycol ethers with branched or linear, saturated or unsaturated alcohols, whereby the polyethylene and polypropylene sections of the surfactant can be grafted next to each other, or they can be randomly interspersed.

All of the above mentioned polycondensates of ethylene oxide and/or propylene oxide with alcohols can be either end group-capped or non-end group-capped.

The polycondensates of ethylene oxide and/or propylene oxide with phenols or substituted phenols are preferably selected from ethoxy- or propoxylated alkylphenols or arylphenols, especially preferably from ethoxylated tristyrylphenol or ethoxylated alkylphenol, such as in particular nonylphenol.

The polyoxyethylene fatty acid esters as described herein include castor oil ethoxylate and are preferably castor oil ethoxylate.

The fatty esters of polyols are preferably fatty acid esters of glycerine, sorbitol or sucrose or ethoxylates thereof, especially preferably esters of polyglycerine ethoxylates or ester of ethoxylated sorbitol.

The polyvinylpyrrolidones (PVP) are preferably selected from copolymers of PVP and dimethylaminoethyl methacrylate or butylated PVP.

Suitable nonionic surfactants are, for example, Soprophor® 796/P, Lucramul® CO30, Lucramul® HOT, Lucramul® PSI 100, Lucramul® PS54, Synperonic® T304, Antarox® B/848, Synperonic® PE series (Uniqema), the Pluronic® PE series (BASF), the VOP® 32 or Genapol® PF series (Clariant).

Particular preference is given to end group-capped and non-end group-capped polycondensates of ethylene oxide and/or propylene oxide with linear or branched, saturated or unsaturated alcohols, polyoxyethylene fatty acid esters or polycondensates of ethylene oxide and/or propylene oxide with phenols or substituted phenols in each case individually or in mixtures.

Very particular preference is given to ethoxylated tristyrylphenol, particularly preferred with 16 to 80 EO groups or ethoxy- and propoxylated linear or branched alcohols, particularly preferred butoxy polyethylene-polypropylene glycols, in each case individually or in mixtures.

Preferably the composition according to the invention comprises more than one surfactant, more preferably the composition comprises a mixture of anionic and non-ionic surfactants.

In a preferred embodiment of the invention the composition comprises one or more surfactants selected from
alkali, alkaline earth and ammonium salts of
   arylsulfonates, especially dodecylbenzenesulfonates,
   aryl polyethoxylated and/or polypropoxylated sulfates, especially polyethoxylated and/or polypropoxylated polyarylphenol sulfates,
   naphthalenesulfonic acid or alkyl naphtalenesulfonic acid,
   formaldehyde condensation products of naphthalenesulfonic acid or alkyl naphtalenesulfonic acid or
   sulfonates of condensed naphtalenes or alkyl napthtalenes,
or further from
   end group-capped and non-end group-capped polycondensates of ethylene oxide and/or propylene oxide with linear or branched, saturated or unsaturated alcohols
   polyoxyethylene fatty acid esters or
   polycondensates of ethylene oxide and/or propylene oxide with phenols or substituted phenols.

In a further preferred embodiment of the invention the composition comprises one or more surfactants selected from
the sodium salt of naphthalene or alkyl naphthalene sulfonate condensates with formaldehyde,
ethoxylated tristyrylphenol with 16 to 80 EO groups,
or ethoxy- and propoxylated linear or branched alcohols, particularly preferred butoxy polyethylene-polypropylene glycols.

The composition may comprise up to 20 wt %, preferably up to 15 wt %, and in particular up to wt % of surfactants c). The composition may comprise from 0.01 to 20 wt %, preferably from 0.05 to 15 wt %, and in particular from 0.1 to 10 wt % of surfactants c).

In certain embodiments, the sum of the weight amounts of component b) water soluble solvents and component c) surfactants may be at least 20 wt %, or at least 30 wt %, or at least 35 wt %, or at least 40 wt %, or at least 45 wt %, or at least 50 wt %, or at least 52 wt %, or at least 54 wt %, or at least 56 wt % of the presently disclosed compositions. In certain embodiments, the sum of the weight amounts of component b) water soluble solvents and component c) surfactants may be from 20 wt % to 85 wt %, or from 25 wt % to 70 wt %, or from 30 wt % to 68 wt % of the presently disclosed compositions.

The composition according to the invention may comprise a further active ingredient e).

In another embodiment the composition according to the invention may comprise one or more further active ingredients e).

The further active ingredient may be present in form of suspended particles and/or in dissolved form. Preferably, the further pesticide may be present in form of suspended particles.

Preferably the further active ingredient e) is also a fungicide, more preferably a fungicide selected from the list below.

The active compounds identified here by their common names are known and are described, for example, in the pesticide handbook (“The Pesticide Manual” 16th Ed., British Crop Protection Council 2012) or can be found on the Internet (e.g. http://www.alanwood.net/pesticides). The classification is based on the current FRAC, HRAC, IRAC Mode of Action Classification Scheme at the time of filing of this patent application.

Examples of fungicides as compound e) are:
1) Inhibitors of the ergosterol biosynthesis, for example (1.001) cyproconazole, (1.002) difenoconazole, (1.003) epoxiconazole, (1.004) fenhexamid, (1.005) fenpropidin, (1.006) fenpropimorph, (1.007) fenpyrazamine, (1.008) fluquinconazole, (1.009) flutriafol, (1.010) imazalil, (1.011) imazalil sulfate, (1.012) ipconazole, (1.013) metconazole, (1.014) myclobutanil, (1.015) paclobutrazol, (1.016) prochloraz, (1.017) propiconazole, (1.018) prothioconazole, (1.019) pyrisoxazole, (1.020) spiroxamine, (1.021) tebuconazole, (1.022) tetraconazole, (1.023) triadimenol, (1.024) tridemorph, (1.025) triticonazole, (1.026) (1R,2S,5S)-5-(4-chlorobenzyl)-2-(chloromethyl)-2-methyl-1-(1H-1,2,4-triazol-1-ylmethyl)cyclopentanol, (1.027) (1S,2R,5R)-5-(4-chlorobenzyl)-2-(chloromethyl)-2-methyl-1-(1H-1,2,4-triazol-1-ylmethyl)cyclopentanol, (1.028) (2R)-2-(1-chlorocyclopropyl)-4-[(1R)-2,2-dichlorocyclopropyl]-1-(1H-1,2,4-triazol-1-yl)butan-2-ol, (1.029) (2R)-2-(1-chlorocyclopropyl)-4-[(1S)-2,2-dichlorocyclopropyl]-1-(1H-1,2,4-triazol-1-yl)butan-2-ol, (1.030) (2R)-2-[4-(4-chlorophenoxy)-2-(trifluoromethyl)phenyl]-1-(1H-1,2,4-triazol-1-yl) propan-2-ol, (1.031) (2S)-2-(1-chlorocyclopropyl)-4-[(1R)-2,2-dichlorocyclopropyl]-1-(1H-1,2,4-triazol-1-yl)butan-2-ol, (1.032) (2S)-2-(1-chlorocyclopropyl)-4-[(1S)-2,2-dichlorocyclopropyl]-1-(1H-1,2,4-triazol-1-yl)butan-2-ol, (1.033) (2S)-2-[4-(4-chlorophenoxy)-2-(trifluoromethyl)phenyl]-1-(1H-1,2,4-triazol-1-yl) propan-2-ol, (1.034) (R)-[3-(4-chloro-2-fluorophenyl)-5-(2,4-difluorophenyl)-1,2-oxazol-4-yl](pyridin-3-yl) methanol, (1.035) (S)-[3-(4-chloro-2-fluorophenyl)-5-(2,4-difluorophenyl)-1,2-oxazol-4-yl](pyridin-3-yl) methanol, (1.036) [3-(4-chloro-2-fluorophenyl)-5-(2,4-difluorophenyl)-1,2-oxazol-4-yl](pyridin-3-yl) methanol, (1.037) 1-({(2R,4S)-2-[2-chloro-4-(4-chlorophenoxy)phenyl]-4-methyl-1,3-dioxolan-2-yl}methyl)-1H-1,2,4-triazole, (1.038) 1-({(2S,4S)-2-[2-chloro-4-(4-chlorophenoxy)phenyl]-4-methyl-1,3-dioxolan-2-yl}methyl)-1H-1,2,4-triazole, (1.039) 1-{[3-(2-chlorophenyl)-2-(2,4-difluorophenyl) oxiran-2-yl]methyl}-1H-1,2,4-triazol-5-yl thiocyanate, (1.040) 1-{[rel(2R,3R)-3-(2-chlorophenyl)-2-(2,4-difluorophenyl) oxiran-2-yl]methyl}-1H-1,2,4-triazol-5-yl thiocyanate, (1.041) 1-{[rel(2R,3S)-3-(2-chlorophenyl)-2-(2,4-difluorophenyl) oxiran-2-yl]methyl}-1H-1,2,4-triazol-5-yl thiocyanate, (1.042) 2-[(2R,4R,5R)-1-(2,4-dichlorophenyl)-5-hydroxy-2,6,6-trimethylheptan-4-yl]-2,4-dihydro-3H-1,2,4-triazole-3-thione, (1.043) 2-[(2R,4R,5S)-1-(2,4-dichlorophenyl)-5-hydroxy-2,6,6-trimethylheptan-4-yl]-2,4-dihydro-3H-1,2,4-triazole-3-thione, (1.044) 2-[(2R,4S,5R)-1-(2,4-dichlorophenyl)-5-hydroxy-2,6,6-trimethylheptan-4-yl]-2,4-dihydro-3H-1,2,4-triazole-3-thione, (1.045) 2-[(2R,4S,5S)-1-(2,4-dichlorophenyl)-5-hydroxy-2,6,6-trimethylheptan-4-yl]-2,4-dihydro-3H-1,2,4-triazole-3-thione, (1.046) 2-[(2S,4R,5R)-1-(2,4-dichlorophenyl)-5-hydroxy-2,6,6-trimethylheptan-4-yl]-2,4-dihydro-3H-1,2,4-triazole-3-thione, (1.047) 2-[(2S,4R,5S)-1-(2,4-dichlorophenyl)-5-hydroxy-2,6,6-trimethylheptan-4-yl]-2,4-dihydro-3H-1,2,4-triazole-3-thione, (1.048) 2-[(2S,4S,5R)-1-(2,4-dichlorophenyl)-5-hydroxy-2,6,6-trimethylheptan-4-yl]-2,4-dihydro-3H-1,2,4-triazole-3-thione, (1.049) 2-[(2S,4S,5S)-1-(2,4-dichlorophenyl)-5-hydroxy-2,6,6-trimethylheptan-4-yl]-2,4-dihydro-3H-1,2,4-triazole-3-thione, (1.050) 2-[1-(2,4-dichlorophenyl)-5-hydroxy-2,6,6-trimethylheptan-4-yl]-2,4-dihydro-3H-1,2,4-triazole-3-thione, (1.051) 2-[2-chloro-4-(2,4-dichlorophenoxy)phenyl]-1-(1H-1,2,4-triazol-1-yl) propan-2-ol, (1.052) 2-[2-chloro-4-(4-chlorophenoxy)phenyl]-1-(1H-1,2,4-triazol-1-yl)butan-2-ol, (1.053) 2-[4-(4-chlorophenoxy)-2-(trifluoromethyl)phenyl]-1-(1H-1,2,4-triazol-1-yl)butan-2-ol, (1.054) 2-[4-(4-chlorophenoxy)-2-(trifluoromethyl)phenyl]-1-(1H-1,2,4-triazol-1-yl) pentan-2-ol, (1.055) Mefentrifluconazole, (1.056) 2-{[3-(2-chlorophenyl)-2-(2,4-difluorophenyl) oxiran-2-yl]methyl}-2,4-dihydro-3H-1,2,4-triazole-3-thione, (1.057) 2-{[rel(2R,3R)-3-(2-chlorophenyl)-2-(2,4-difluorophenyl) oxiran-2-yl]methyl}-2,4-dihydro-3H-1,2,4-triazole-3-thione, (1.058) 2-{[rel(2R,3S)-3-(2-chlorophenyl)-2-(2,4-difluorophenyl) oxiran-2-yl]methyl}-2,4-dihydro-3H-1,2,4-triazole-3-thione, (1.059) 5-(4-chlorobenzyl)-2-(chloromethyl)-2-methyl-1-(1H-1,2,4-triazol-1-ylmethyl)cyclopentanol, (1.060) 5-(allylsulfanyl)-1-{[3-(2-chlorophenyl)-2-(2,4-difluorophenyl) oxiran-2-yl]methyl}-1H-1,2,4-triazole, (1.061) 5-(allylsulfanyl)-1-{[rel(2R,3R)-3-(2-chlorophenyl)-2-(2,4-difluorophenyl) oxiran-2-yl]methyl}-1H-1,2,4-triazole, (1.062) 5-(allylsulfanyl)-1-{[rel(2R,3S)-3-(2-chlorophenyl)-2-(2,4-difluorophenyl) oxiran-2-yl]methyl}-1H-1,2,4-triazole, (1.063) N′-(2,5-dimethyl-4-{[3-(1,1,2,2-tetrafluoroethoxy)phenyl]-sulfanyl}phenyl)-N-ethyl-N-methylimidoformamide, (1.064) N′-(2,5-dimethyl-4-{[3-(2,2,2-trifluoroethoxy)phenyl]sulfanyl}phenyl)-N-ethyl-N-methylimidoformamide, (1.065) N′-(2,5-dimethyl-4-{[3-(2,2,3,3-tetrafluoropropoxy)phenyl]sulfanyl}phenyl)-N-ethyl-N-methylimidoformamide, (1.066) N′-(2,5-dimethyl-4-{[3-(pentafluoroethoxy)phenyl]sulfanyl}phenyl)-N-ethyl-N-methylimidoformamide, (1.067) N′-(2,5-dimethyl-4-{3-[(1,1,2,2-tetrafluoroethyl) sulfanyl]phenoxy}phenyl)-N-ethyl-N-methyl-imidoformamide, (1.068) N′-(2,5-dimethyl-4-{3-[(2,2,2-trifluoroethyl) sulfanyl]phenoxy}phenyl)-N-ethyl-N-methylimidoformamide, (1.069) N′-(2,5-dimethyl-4-{3-[(2,2,3,3-tetrafluoropropyl) sulfanyl]phenoxy}phenyl)-N-ethyl-N-methylimidoformamide, (1.070) N′-(2,5-dimethyl-4-{3-[(pentafluoro-ethyl) sulfanyl]phenoxy}phenyl)-N-ethyl-N-methylimidoformamide, (1.071) N′-(2,5-dimethyl-4-phenoxyphenyl)-N-ethyl-N-methylimidoformamide, (1.072) N′-(4-{[3-(difluoromethoxy)-phenyl]sulfanyl}-2,5-dimethylphenyl)-N-ethyl-N-methylimidoformamide, (1.073) N′-(4-{3-[(difluoromethyl) sulfanyl]phenoxy}-2,5-dimethylphenyl)-N-ethyl-N-methylimidoformamide, (1.074) N′-[5-bromo-6-(2,3-dihydro-1H-inden-2-yloxy)-2-methylpyridin-3-yl]-N-ethyl-N-methylimidoformamide, (1.075) N′-{4-[(4,5-dichloro-1,3-thiazol-2-yl)oxy]-2,5-dimethylphenyl}-N-ethyl-N-methylimidoformamide, (1.076) N′-{5-bromo-6-[(1R)-1-(3,5-difluorophenyl) ethoxy]-2-methylpyridin-3-yl}-N-ethyl-N-methylimidoformamide, (1.077) N′-{5-bromo-6-[(1S)-1-(3,5-difluorophenyl) ethoxy]-2-methylpyridin-3-yl}-N-ethyl-N-methylimidoformamide, (1.078) N′-{5-bromo-6-[(cis-4-isopropylcyclohexyl)oxy]-2-methylpyridin-3-yl}-N-ethyl-N-methylimidoformamide, (1.079) N′-{5-bromo-6-[(trans-4-isopropylcyclohexyl)oxy]-2-methylpyridin-3-yl}-N-ethyl-N-methylimidoformamide, (1.080) N′-{5-bromo-6-[1-(3,5-difluorophenyl) ethoxy]-2-methylpyridin-3-yl}-N-ethyl-N-methylimido-formamide, (1.081) ipfentrifluconazole, (1.082) 2-[4-(4-chlorophenoxy)-2-(trifluoromethyl)phenyl]-1-(1H-1,2,4-triazol-1-yl) propan-2-ol, (1.083) 2-[6-(4-bromophenoxy)-2-(trifluoromethyl)-3-pyridyl]-1-(1,2,4-triazol-1-yl) propan-2-ol, (1.084) 2-[6-(4-chlorophenoxy)-2-(trifluoromethyl)-3-pyridyl]-1-(1,2,4-triazol-1-yl) propan-2-ol, (1.085) 3-[2-(1-chlorocyclopropyl)-3-(3-chloro-2-fluoro-phenyl)-2-hydroxy-propyl]imidazole-4-carbonitrile and (1.086) 4-[[6-[rac-(2R)-2-(2,4-difluorophenyl)-1,1-difluoro-2-hydroxy-3-(5-thioxo-4H-1,2,4-triazol-1-yl) propyl]-3-pyridyl]oxy]benzonitrile.

2) Inhibitors of the respiratory chain at complex I or II, for example (2.001) benzovindiflupyr, (2.002) bixafen, (2.003) boscalid, (2.004) carboxin, (2.005) fluopyram, (2.006) flutolanil, (2.007) fluxapyroxad, (2.008) furametpyr, (2.009) Isofetamid, (2.010) isopyrazam (anti-epimeric enantiomer 1R,4S,9S), (2.011) isopyrazam (anti-epimeric enantiomer 1S,4R,9R), (2.012) isopyrazam (anti-epimeric racemate 1RS,4SR,9SR), (2.013) isopyrazam (mixture of syn-epimeric racemate 1RS,4SR,9RS and anti-epimeric racemate 1RS,4SR,9SR), (2.014) isopyrazam (syn-epimeric enantiomer 1R,4S,9R), (2.015) isopyrazam (syn-epimeric enantiomer 1S,4R,9S), (2.016) isopyrazam (syn-epimeric racemate 1RS,4SR,9RS), (2.017) penflufen, (2.018) penthiopyrad, (2.019) pydiflumetofen, (2.020) Pyraziflumid, (2.021) sedaxane, (2.022) 1,3-dimethyl-N-(1,1,3-trimethyl-2,3-dihydro-1H-inden-4-yl)-1H-pyrazole-4-carboxamide, (2.023) 1,3-dimethyl-N-[(3R)-1,1,3-trimethyl-2,3-dihydro-1H-inden-4-yl]-1H-pyrazole-4-carboxamide, (2.024) 1,3-dimethyl-N-[(3S)-1,1,3-trimethyl-2,3-dihydro-1H-inden-4-yl]-1H-pyrazole-4-carboxamide, (2.025) 1-methyl-3-(trifluoromethyl)-N-[2′-(trifluoromethyl) biphenyl-2-yl]-1H-pyrazole-4-carboxamide, (2.026) 2-fluoro-6-(trifluoromethyl)-N-(1,1,3-trimethyl-2,3-dihydro-1H-inden-4-yl)benzamide, (2.027) 3-(difluoromethyl)-1-methyl-N-(1,1,3-trimethyl-2,3-dihydro-1H-inden-4-yl)-1H-pyrazole-4-carboxamide, (2.028) inpyrfluxam, (2.029) 3-(difluoromethyl)-1-methyl-N-[(3S)-1,1,3-trimethyl-2,3-dihydro-1H-inden-4-yl]-1H-pyrazole-4-carboxamide, (2.030) fluindapyr, (2.031) 3-(difluoromethyl)-N-[(3R)-7-fluoro-1,1,3-trimethyl-2,3-dihydro-1H-inden-4-yl]-1-methyl-1H-pyrazole-4-carboxamide, (2.032) 3-(difluoromethyl)-N-[(3S)-7-fluoro-1,1,3-trimethyl-2,3-dihydro-1H-inden-4-yl]-1-methyl-1H-pyrazole-4-carboxamide, (2.033) 5,8-difluoro-N-[2-(2-fluoro-4-{[4-(trifluoromethyl)pyridin-2-yl]oxy}phenyl)ethyl]quinazolin-4-amine, (2.034) N-(2-cyclopentyl-5-fluorobenzyl)-N-cyclopropyl-3-(difluoromethyl)-5-fluoro-1-methyl-1H-pyrazole-4-carboxamide, (2.035) N-(2-tert-butyl-5-methylbenzyl)-N-cyclopropyl-3-(difluoromethyl)-5-fluoro-1-methyl-1H-pyrazole-4-carboxamide, (2.036) N-(2-tert-butylbenzyl)-N-cyclopropyl-3-(difluoromethyl)-5-fluoro-1-methyl-1H-pyrazole-4-carboxamide, (2.037) N-(5-chloro-2-ethylbenzyl)-N-cyclopropyl-3-(difluoromethyl)-5-fluoro-1-methyl-1H-pyrazole-4-carboxamide, (2.038) isoflucypram, (2.039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide, (2.040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide, (2.041) N-[1-(2,4-dichlorophenyl)-1-methoxypropan-2-yl]-3-(difluoromethyl)-1-methyl-1H-pyrazole-4-carboxamide, (2.042) N-[2-chloro-6-(trifluoromethyl)benzyl]-N-cyclopropyl-3-(difluoromethyl)-5-fluoro-1-methyl-1H-pyrazole-4-carboxamide, (2.043) N-[3-chloro-2-fluoro-6-(trifluoromethyl)benzyl]-N-cyclopropyl-3-(difluoromethyl)-5-fluoro-1-methyl-1H-pyrazole-4-carboxamide, (2.044) N-[5-chloro-2-(trifluoromethyl)benzyl]-N-cyclopropyl-3-(difluoromethyl)-5-fluoro-1-methyl-1H-pyrazole-4-carboxamide, (2.045) N-cyclopropyl-3-(difluoromethyl)-5-fluoro-1-methyl-N-[5-methyl-2-(trifluoromethyl)benzyl]-1H-pyrazole-4-carboxamide, (2.046) N-cyclopropyl-3-(difluoromethyl)-5-fluoro-N-(2-fluoro-6-isopropylbenzyl)-1-methyl-1H-pyrazole-4-carboxamide, (2.047) N-cyclopropyl-3-(difluoromethyl)-5-fluoro-N-(2-isopropyl-5-methylbenzyl)-1-methyl-1H-pyrazole-4-carboxamide, (2.048) N-cyclopropyl-3-(difluoromethyl)-5-fluoro-N-(2-isopropylbenzyl)-1-methyl-1H-pyrazole-4-carbothioamide, (2.049) N-cyclopropyl-3-(difluoromethyl)-5-fluoro-N-(2-isopropylbenzyl)-1-methyl-1H-pyrazole-4-carboxamide, (2.050) N-cyclopropyl-3-(difluoromethyl)-5-fluoro-N-(5-fluoro-2-isopropylbenzyl)-1-methyl-1H-pyrazole-4-carboxamide, (2.051) N-cyclopropyl-3-(difluoromethyl)-N-(2-ethyl-4,5-dimethylbenzyl)-5-fluoro-1-methyl-1H-pyrazole-4-carboxamide, (2.052) N-cyclopropyl-3-(difluoromethyl)-N-(2-ethyl-5-fluorobenzyl)-5-fluoro-1-methyl-1H-pyrazole-4-carboxamide, (2.053) N-cyclopropyl-3-(difluoromethyl)-N-(2-ethyl-5-methylbenzyl)-5-fluoro-1-methyl-1H-pyrazole-4-carboxamide, (2.054) N-cyclopropyl-N-(2-cyclopropyl-5-fluorobenzyl)-3-(difluoromethyl)-5-fluoro-1-methyl-1H-pyrazole-4-carboxamide, (2.055) N-cyclopropyl-N-(2-cyclopropyl-5-methylbenzyl)-3-(difluoromethyl)-5-fluoro-1-methyl-1H-pyrazole-4-carboxamide, (2.056) N-cyclopropyl-N-(2-cyclopropylbenzyl)-3-(difluoromethyl)-5-fluoro-1-methyl-1H-pyrazole-4-carboxamide, (2.057) pyrapropoyne.

3) Inhibitors of the respiratory chain at complex III, for example (3.001) ametoctradin, (3.002) amisulbrom, (3.003) azoxystrobin, (3.004) coumethoxystrobin, (3.005) coumoxystrobin, (3.006) cyazofamid, (3.007) dimoxystrobin, (3.008) enoxastrobin, (3.009) famoxadone, (3.010) fenamidone, (3.011) flufenoxystrobin, (3.012) fluoxastrobin, (3.013) kresoxim-methyl, (3.014) metominostrobin, (3.015) orysastrobin, (3.016) picoxystrobin, (3.017) pyraclostrobin, (3.018) pyrametostrobin, (3.019) pyraoxystrobin, (3.020) trifloxystrobin, (3.021) (2E)-2-{2-[({[(1E)-1-(3-{[(E)-1-fluoro-2-phenylvinyl]oxy}phenyl)ethylidene]amino}oxy)methyl]phenyl}-2-(methoxyimino)-N-methylacetamide, (3.022) (2E,3Z)-5-{[1-(4-chlorophenyl)-1H-pyrazol-3-yl]oxy}-2-(methoxyimino)-N,3-dimethylpent-3-enamide, (3.023) (2R)-2-{2-[(2,5-dimethylphenoxy)methyl]phenyl}-2-methoxy-N-methylacetamide, (3.024) (2S)-2-{2-[(2,5-dimethylphenoxy)methyl]phenyl}-2-methoxy-N-methylacetamide, (3.025) fenpicoxamid, (3.026) mandestrobin, (3.027) N-(3-ethyl-3,5,5-trimethylcyclohexyl)-3-formamido-2-hydroxybenzamide, (3.028) (2E,3Z)-5-{[1-(4-chloro-2-fluorophenyl)-1H-pyrazol-3-yl]oxy}-2-(methoxyimino)-N,3-dimethylpent-3-enamide, (3.029)methyl {5-[3-(2,4-dimethylphenyl)-1H-pyrazol-1-yl]-2-methylbenzyl}carbamate, (3.030) metyltetraprole, (3.031) florylpicoxamid. 4) Inhibitors of the mitosis and cell division, for example (4.001) carbendazim, (4.002) diethofencarb, (4.003) ethaboxam, (4.004) fluopicolide, (4.005) pencycuron, (4.006) thiabendazole, (4.007) thiophanate-methyl, (4.008) zoxamide, (4.009) 3-chloro-4-(2,6-difluorophenyl)-6-methyl-5-phenylpyridazine, (4.010) 3-chloro-5-(4-chlorophenyl)-4-(2,6-difluorophenyl)-6-methylpyridazine, (4.011) 3-chloro-5-(6-chloropyridin-3-yl)-6-methyl-4-(2,4,6-trifluorophenyl) pyridazine, (4.012) 4-(2-bromo-4-fluorophenyl)-N-(2,6-difluorophenyl)-1,3-dimethyl-1H-pyrazol-5-amine, (4.013) 4-(2-bromo-4-fluorophenyl)-N-(2-bromo-6-fluorophenyl)-1,3-dimethyl-1H-pyrazol-5-amine, (4.014) 4-(2-bromo-4-fluorophenyl)-N-(2-bromophenyl)-1,3-dimethyl-1H-pyrazol-5-amine, (4.015) 4-(2-bromo-4-fluorophenyl)-N-(2-chloro-6-fluorophenyl)-1,3-dimethyl-1H-pyrazol-5-amine, (4.016) 4-(2-bromo-4-fluorophenyl)-N-(2-chlorophenyl)-1,3-dimethyl-1H-pyrazol-5-amine, (4.017) 4-(2-bromo-4-fluorophenyl)-N-(2-fluorophenyl)-1,3-dimethyl-1H-pyrazol-5-amine, (4.018) 4-(2-chloro-4-fluorophenyl)-N-(2,6-difluorophenyl)-1,3-dimethyl-1H-pyrazol-5-amine, (4.019) 4-(2-chloro-4-fluorophenyl)-N-(2-chloro-6-fluorophenyl)-1,3-dimethyl-1H-pyrazol-5-amine, (4.020) 4-(2-chloro-4-fluorophenyl)-N-(2-chlorophenyl)-1,3-dimethyl-1H-pyrazol-5-amine, (4.021) 4-(2-chloro-4-fluorophenyl)-N-(2-fluorophenyl)-1,3-dimethyl-1H-pyrazol-5-amine, (4.022) 4-(4-chlorophenyl)-5-(2,6-difluorophenyl)-3,6-dimethylpyridazine, (4.023) N-(2-bromo-6-fluorophenyl)-4-(2-chloro-4-fluorophenyl)-1,3-dimethyl-1H-pyrazol-5-amine, (4.024) N-(2-bromophenyl)-4-(2-chloro-4-fluorophenyl)-1,3-dimethyl-1H-pyrazol-5-amine, (4.025) N-(4-chloro-2,6-difluorophenyl)-4-(2-chloro-4-fluorophenyl)-1,3-dimethyl-1H-pyrazol-5-amine.

5) Compounds capable to have a multisite action, for example (5.001) bordeaux mixture, (5.002) captafol, (5.003) captan, (5.004) chlorothalonil, (5.005) copper hydroxide, (5.006) copper naphthenate, (5.007) copper oxide, (5.008) copper oxychloride, (5.009) copper(2+) sulfate, (5.010) dithianon, (5.011) dodine, (5.012) folpet, (5.013) mancozeb, (5.014) maneb, (5.015) metiram, (5.016) metiram zinc, (5.017) oxine-copper, (5.018) propineb, (5.019) sulfur and sulfur preparations including calcium polysulfide, (5.020) thiram, (5.021) zineb, (5.022) ziram, (5.023) 6-ethyl-5,7-dioxo-6,7-dihydro-5H-pyrrolo[3′,4′:5,6][1,4]dithiino[2,3-c][1,2]thiazole-3-carbonitrile.

6) Compounds capable to induce a host defence, for example (6.001) acibenzolar-S-methyl, (6.002) isotianil, (6.003) probenazole, (6.004) tiadinil.

7) Inhibitors of the amino acid and/or protein biosynthesis, for example (7.001) cyprodinil, (7.002) kasugamycin, (7.003) kasugamycin hydrochloride hydrate, (7.004) oxytetracycline, (7.005) pyrimethanil, (7.006) 3-(5-fluoro-3,3,4,4-tetramethyl-3,4-dihydroisoquinolin-1-yl) quinolone.

8) Inhibitors of the ATP production, for example (8.001) silthiofam.

9) Inhibitors of the cell wall synthesis, for example (9.001) benthiavalicarb, (9.002) dimethomorph, (9.003) flumorph, (9.004) iprovalicarb, (9.005) mandipropamid, (9.006) pyrimorph, (9.007) valifenalate, (9.008) (2E)-3-(4-tert-butylphenyl)-3-(2-chloropyridin-4-yl)-1-(morpholin-4-yl) prop-2-en-1-one, (9.009) (2Z)-3-(4-tert-butylphenyl)-3-(2-chloropyridin-4-yl)-1-(morpholin-4-yl) prop-2-en-1-one.

10) Inhibitors of the lipid and membrane synthesis, for example (10.001) propamocarb, (10.002) propamocarb hydrochloride, (10.003) tolclofos-methyl.

11) Inhibitors of the melanin biosynthesis, for example (11.001) tricyclazole, (11.002) tolprocarb.

12) Inhibitors of the nucleic acid synthesis, for example (12.001) benalaxyl, (12.002) benalaxyl-M (kiralaxyl), (12.003) metalaxyl, (12.004) metalaxyl-M (mefenoxam).

13) Inhibitors of the signal transduction, for example (13.001) fludioxonil, (13.002) iprodione, (13.003) procymidone, (13.004) proquinazid, (13.005) quinoxyfen, (13.006) vinclozolin.

14) Compounds capable to act as an uncoupler, for example (14.001) fluazinam, (14.002) meptyldinocap.

15) Other fungicides, for example (15.001) abscisic acid, (15.002) benthiazole, (15.003) bethoxazin, (15.004) capsimycin, (15.005) carvone, (15.006) chinomethionat, (15.007) cufraneb, (15.008) cyflufenamid, (15.009) cymoxanil, (15.010) cyprosulfamide, (15.011) flutianil, (15.012) methyl isothiocyanate, (15.016) metrafenone, (15.017) mildiomycin, (15.018) natamycin, (15.019) nickel dimethyldithiocarbamate, (15.020) nitrothal-isopropyl, (15.021) oxamocarb, (15.022) Oxathiapiprolin, (15.023) oxyfenthiin, (15.024) pentachlorophenol and salts, (15.025) phosphorous acid and its salts, (15.026) propamocarb-fosetylate, (15.027) pyriofenone (chlazafenone), (15.028) tebufloquin, (15.029) tecloftalam, (15.030) tolnifanide, (15.031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone, (15.033) 2-(6-benzylpyridin-2-yl)quinazoline, (15.034) dipymetitrone, (15.035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl) piperidin-1-yl]ethanone, (15.036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl) piperidin-1-yl]ethanone, (15.037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl) piperidin-1-yl]ethanone, (15.038) 2-[6-(3-fluoro-4-methoxyphenyl)-5-methylpyridin-2-yl]quinazoline, (15.039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate, (15.041) Ipflufenoquin, (15.042) 2-{2-fluoro-6-[(8-fluoro-2-methylquinolin-3-yl)oxy]phenyl}propan-2-ol, (15.043) fluoxapiprolin, (15.044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenyl methanesulfonate, (15.045) 2-phenylphenol and salts, (15.046) 3-(4,4,5-trifluoro-3,3-dimethyl-3,4-dihydroisoquinolin-1-yl) quinoline, (15.047) quinofumelin, (15.048) 4-amino-5-fluoropyrimidin-2-ol (tautomeric form: 4-amino-5-fluoropyrimidin-2(1H)-one), (15.049) 4-oxo-4-[(2-phenylethyl)amino]butanoic acid, (15.050) 5-amino-1,3,4-thiadiazole-2-thiol, (15.051) 5-chloro-N′-phenyl-N′-(prop-2-yn-1-yl)thiophene-2-sulfonohydrazide, (15.052) 5-fluoro-2-[(4-fluorobenzyl)oxy]pyrimidin-4-amine, (15.053) 5-fluoro-2-[(4-methylbenzyl)oxy]pyrimidin-4-amine, (15.054) 9-fluoro-2,2-dimethyl-5-(quinolin-3-yl)-2,3-dihydro-1,4-benzoxazepine, (15.055) but-3-yn-1-yl {6-[({[(Z)-(1-methyl-1H-tetrazol-5-yl) (phenyl)methylene]amino}oxy)methyl]pyridin-2-yl}carbamate, (15.056) ethyl(2Z)-3-amino-2-cyano-3-phenylacrylate, (15.057) phenazine-1-carboxylic acid, (15.058) propyl 3,4,5-trihydroxybenzoate, (15.059) quinolin-8-ol, (15.060) quinolin-8-ol sulfate (2:1), (15.061) tert-{6-[({[(1-methyl-1H-tetrazol-5-yl) (phenyl)methylene]amino}oxy)methyl]pyridin-2-butyl 5-fluoro-4-imino-3-methyl-1-[(4-methylphenyl) sulfonyl]-3,4-yl}carbamate, (15.062) dihydropyrimidin-2(1H)-one, (15.063) aminopyrifen, (15.064) (N′-[2-chloro-4-(2-fluorophenoxy)-5-methylphenyl]-N-ethyl-N-methylimidoformamide), (15.065) (N′-(2-chloro-5-methyl-4-phenoxyphenyl)-N-ethyl-N-methylimidoformamide), (15.066) (2-{2-[(7,8-difluoro-2-methylquinolin-3-yl)oxy]-6-fluorophenyl}propan-2-ol), (15.067) (5-bromo-1-(5,6-dimethylpyridin-3-yl)-3,3-dimethyl-3,4-dihydroisoquinoline), (15.068) (3-(4,4-difluoro-5,5-dimethyl-4,5-dihydrothieno[2,3-c]pyridin-7-yl) quinoline), (15.069) (1-(4,5-dimethyl-1H-benzimidazol-1-yl)-4,4-difluoro-3,3-dimethyl-3,4-dihydroisoquinoline), (15.070) 8-fluoro-3-(5-fluoro-3,3-dimethyl-3,4-dihydroisoquinolin-1-yl) quinolone, (15.071) 8-fluoro-3-(5-fluoro-3,3,4,4-tetramethyl-3,4-dihydroisoquinolin-1-yl) quinolone, (15.072) 3-(4,4-difluoro-3,3-dimethyl-3,4-dihydroisoquinolin-1-yl)-8-fluoroquinoline, (15.073) (N-methyl-N-phenyl-4-[5-(trifluoromethyl)-1,2,4-oxadiazol-3-yl]benzamide), (15.074) (methyl {4-[5-(trifluoromethyl)-1,2,4-oxadiazol-3-yl]phenyl}carbamate), (15.075) (N-{4-[5-(trifluoromethyl)-1,2,4-oxadiazol-3-yl]benzyl}cyclopropanecarboxamide), (15.076) N-methyl-4-(5-(trifluoromethyl)-1,2,4-oxadiazol-3-yl]benzamide, (15.077) N-[(E)-methoxyiminomethyl]-4-[5-(trifluoromethyl)-1,2,4-oxadiazol-3-yl]benzamide, (15.078) N—[(Z)-methoxyiminomethyl]-4-[5-(trifluoromethyl)-1,2,4-oxadiazol-3-yl]benzamide, (15.079) N-[4-[5-(trifluoromethyl)-1,2,4-oxadiazol-3-yl]phenyl]-cyclopropanecarboxamide, (15.080) N-(2-fluorophenyl)-4-[5-(trifluoromethyl)-1,2,4-oxadiazol-3-yl]benzamide, (15.081) 2,2-difluoro-N-methyl-2-[4-[5-(trifluoromethyl)-1,2,4-oxadiazol-3-yl]phenyl]acetamide, (15.082) N-allyl-N-[[4-[5-(trifluoromethyl)-1,2,4-oxadiazol-3-yl)phenyl]methyl]acetamide, (15.083) N-[(E)-N-methoxy-C-methyl-carbonimidoyl]-4-(5-(trifluoromethyl)-1,2,4-oxadiazol-3-yl]benzamide, (15.084) N—[(Z)—N-methoxy-C-methyl-carbonimidoyl]-4-[5-(trifluoromethyl)-1,2,4-oxadiazol-3-yl]benzamide, (15.085) N-allyl-N-[[4-[5-(trifluoromethyl)-1,2,4-oxadiazol-3-yl]phenyl]methyl]propanamide, (15.086) 4,4-dimethyl-1-[[4-[5-(trifluoromethyl)-1,2,4-oxadiazol-3-yl]phenyl]methyl]pyrrolidin-2-one, (15.087) N-methyl-4-[5-(trifluoromethyl)-1,2,4-oxadiazol-3-yl]benzenecarbothioamide, (15.088) 5-methyl-1-[[4-[5-(trifluoromethyl)-1,2,4-oxadiazol-3-yl]phenyl]methyl]pyrrolidin-2-one, (15.089) N-((2,3-difluoro-4-[5-(trifluoromethyl)-1,2,4-oxadiazol-3-yl]phenyl]methyl]-3,3,3-trifluoro-propanamide, (15.090) 1-methoxy-1-methyl-3-[[4-[5-(trifluoromethyl}-1,2,4-oxadiazol-3-yl]phenyl]methyl]urea, (15.091) 1,1-diethyl-3-[[4-[5-(trifluoromethyl}-1,2,4-oxadiazol-3-yl]phenyl]methyl]urea, (15.092) N-[[4-[5-(trifluoromethyl)-1,2,4-oxadiazol-3-yl]phen-yl]methyl]propanamide, (15.093) N-methoxy-N-[[4-[5-(trifluoromethyl)-1,2,4-oxadiazol-3-yl]phenyl]methyl]cyclopropanecarboxamide, (15.094) 1-methoxy-3-methyl-1-[[4-[5-(trifluoromethyl)-1,2,4-oxadiazol-3-yl]phenyl]methyl]urea, (15.095) N-methoxy-N-[[4-[5-(trifluoromethyl)-1,2,4-oxadiazol-3-yl]phenyl]methyl)cyclopropanecarboxamide, (15.096) N,2-dimethoxy-N-[4-[5-(trifluoromethyl}-1,2,4-oxadiazol-3-yl]phenyl]methyl]propanamide, (15.097) N-ethyl-2-methyl-N-[[4-[5-(trifluoromethyl)-1,2,4-oxadiazol-3-yl)phenyl]methyl]-propanamide, (15.098) 1-methoxy-3-methyl-1-[[4-[5-(trifluoromethyl)-1,2,4-oxadiazol-3-yl]phenyl]methyl]urea, (15.099) 1,3-dimethoxy-1-[[4-[5-(trifluoromethyl)-1,2,4-oxadiazol-3-yl]phenyl]methyl]urea, (15.100) 3-ethyl-1-methoxy-1-[[4-[5-(trifluoromethyl)-1,2,4-oxadiazol-3-yl]phenyl]methyl]urea, (15.101) 1-[[4-[5-(trifluoromethyl)-1,2,4-oxadiazol-3-yl]phenyl]methyl]piperidin-2-one, (15.102) 4,4-dimethyl-2-[[4-[5-(trifluoromethyl)-1,2,4-oxadiazol-3-yl]phenyl]methyl]isooxazolidin-3-one, (15.103) 5,5-dimethyl-2-[[4-[5-(trifluoromethyl)-1,2,4-oxadiazol-3-yl]phenyl]methyl]isoxazolidin-3-one, (15.104) 3,3-dimethyl-1-[[4-[5-(trifluoromethyl)-1,2,4-oxadiazol-3-yl]phenyl]methyl]piperidin-2-one, (15.105) 1-[[3-fluoro-4-(5-(trifluoromethyl)-1,2,4-oxadiazol-3-yl]phenyl]methyl]azepan-2-one, (15.106) 4,4-dimethyl-2-[[4-(5-(trifluoromethyl)-1,2,4-oxadiazol-3-yl]phenyl]-methyl]isoxazolidin-3-one (15.107) 5,5-dimethyl-2-[[4-[5-(trifluoromethyl)-1,2,4-oxadiazol-3-yl]phenyl]methyl]isoxazolidin-3-one, (15.108) ethyl (1-{4-[5-(trifluoromethyl)-1,2,4-oxadiazol-3-yl]benzyl}-1H-pyrazol-4-yl) acetate, (15.109) N,N-dimethyl-1-{4-[5-(trifluoromethyl)-1,2,4-oxadiazol-3-yl]benzyl}-1H-1,2,4-triazol-3-amine, (15.110) N-{2,3-difluoro-4-[5-(trifluoromethyl)-1,2,4-oxadiazol-3-yl]benzyl}butanamide, (15.111) N-(1-methylcyclopropyl)-4-[5-(trifluoromethyl)-1,2,4-oxadiazol-3-yl]benzamide, (15.112) N-(2,4-difluorophenyl)-4-[5-(trifluoromethyl)-1,2,4-oxadiazol-3-yl]benzamide, (15.113) 1-(5,6-dimethylpyridin-3-yl)-4,4-difluoro-3,3-dimethyl-3,4-dihydroisoquinoline, (15.114) 1-(6-(difluoromethyl)-5-methyl-pyridin-3-yl)-4,4-difluoro-3,3-dimethyl-3,4-dihydroisoquinoline, (15.115) 1-(5-(fluoromethyl)-6-methyl-pyridin-3-yl)-4,4-difluoro-3,3-dimethyl-3,4-dihydroisoquinoline and (15.116) 1-(6-(difluoromethyl)-5-methoxy-pyridin-3-yl)-4,4-difluoro-3,3-dimethyl-3,4-dihydroisoquinoline.

All named mixing partners of the classes (1) to (15) as described here above can be present in the form of the free compound or, if their functional groups enable this, an agrochemically active salt thereof.

The composition may comprise up to 60 wt %, preferably up to 40 wt %, and in particular up to 20 wt % of the further active ingredient e). The composition may comprise from 0 to 60 wt %, preferably from 0.5 to 40 wt %, and in particular from 1 to 20 wt % of the further active ingredient e).

In a preferred embodiment of the invention the composition comprises no additional active ingredient e).

The composition according to then invention may also comprise f) a further formulation additive.

In a special embodiment the composition of the present disclosure further comprises compound f), one or more further formulation additives.

The further additives can be all auxiliaries commonly used in the formulation of agrochemically active ingredients, but they are preferably selected from anti-foaming agents, humectants, stabilizers or pH-adjusters, more preferably they are anti-foaming agents.

The further formulation additives f) cannot be selected from the thickeners as defined below.

The anti-foaming agent may be selected from are all substances typically usable for this purpose in agrochemical compositions.

Preferably the anti-foaming agent is selected from
silicone antifoams, including silicone oils and silicone oil preparations,
magnesium stearate,
long chain alcohols or
salts of fatty acids.

Examples are Silcolapse® 426R and 432 from Bluestar Silicones, Silfoam® SRE, SC132 and SC1132 from Wacker, SAG 1572 and SAG 30 from Momentive.

More preferably the anti-foam agent is a silicone based antifoam, even more preferably a polysiloxane based antifoam, particularly the antifoam is based on polydimethylsiloxane.

Useful humectants are all substances typically usable for this purpose in agrochemical compositions. Preference is given to water-soluble liquids.

Useful stabilizers are all substances typically usable for this purpose in agrochemical compositions.

Suitable stabilizers by way of example are
antifreeze, cold stabilizers, e.g. propylene glycol, ethylene glycol, urea, inorganic salts (e.g. sodium chloride, potassium chloride, sodium sulfate, potassium sulfate.)
preservatives, e.g. dichlorophene and benzyl alcohol hemiformal, 5-chloro-2-methyl-4-isothiazolin-3-one [CAS-No. 26172-55-4], 2-methyl-4-isothiazolin-3-one [CAS-No. 2682-20-4] or 1.2-benzisothiazol-3 (2H)-one [CAS-No. 2634-33-5]. Examples which may be mentioned are Preventol® D7 (Lanxess), Kathon® CG/ICP (Dow), Acticide® SPX (Thor GmbH) and Proxel® GXL (Arch Chemicals).
Antioxidants, such as butylhydroxytoluene [3.5-Di-tert-butyl-4-hydroxytoluol, CAS-No. 128-37-0]
light stabilizers, in particular UV stabilizers,
other agents which improve chemical and/or physical stability,
acids or bases, such as citric acid, formic acid, acetic acid or boric acid, sodium salts of carboxylic acids and mono- or poly-alkyl-substituted amines.

Useful pH adjusters are all substances typically usable for this purpose in agrochemical compositions.

Suitable pH adjusters by way of example are
acids and bases, such as hydrochloric acid, sulfuric acid, citric acid or sodium hydroxide and potassium hydroxide;
buffers, e.g. suitable combinations of phosphate salts, or of citrate salts known in the literature to stabilize a concrete pH range.

The composition may comprise up to 15 wt %, preferably up to 10 wt %, and in particular up to 5 wt % of further formulation additives f). The composition may comprise from 0.01 to 15 wt %, preferably from 0.02 to 10 wt %, and in particular from 0.05 to 5 wt % of further formulation additives f).

The composition according to then invention may also comprise g) a biopesticide, biostimulant, and/or biofertilizer.

In a special embodiment the composition of the present disclosure further comprises compound g), one or more biopesticide, biostimulant, and/or biofertilizer.

As used herein, the term “biopesticide,” in all of its forms, refers to certain pesticides that are derived from natural materials such as animals, plants, and certain minerals, including, but not limited to, microbial pesticides consisting of a microorganism, such as a bacterium, fungus, virus, or protozoan, pesticidal substances that may be produced by a plant as a result of genetic modification of the plant, and naturally occurring substances that control pests by toxic and/or non-toxic mechanisms.

As used herein, the term “biostimulant,” in all of its forms, refers to certain substances and microbes that may be used to stimulate plant growth, enhance resistance to plant pests, and/or reduce abiotic stress. Biostimulants may include, for example, substances or microorganisms that when applied to seeds, plants, or the rhizosphere, stimulates natural processes to enhance or benefit nutrient uptake, increase nutrient efficiency, increase tolerance to abiotic stress, increase crop quality, or increase crop yield. Other examples of biostiumulants may include naturally occurring substance, or its synthetically-derived mimic or equivalent, or a microbe that is used for the purpose for stimulating natural processes in plants or in the soil in order to, among other possibilities, improve nutrient and/or water us efficiency by plants, help plants tolerate abiotic stress, or improve characteristics of the soil as a medium for plant growth. Additional non-limiting examples of biostimulants may include substances, microorganisms, or mixtures thereof, that, when applied to seeds, plants, the rhizosphere, soil or other growth media, improve nutrient availability, uptake or use efficiency by plants, plant tolerance to abiotic stress, and consequent growth, development, quality or yield of plants.

As used herein, the term “biofertilizers,” in all of its forms, refers to substances containing living micro-organisms which, when applied to seeds, plant surfaces, or soil, colonize the rhizosphere or the interior of the plant and promote growth by increasing the supply or availability of nutrients to the host plant. Non-limiting examples of biofertilizers may include, for example, substances and micro-organisms providing plants with nutrients through the processes of nitrogen fixation, solubilizing phosphorus, and/or growth-promoting substances. Another non-limiting example of biofertilizers may include plant-growth promoting rhizobacteria (PGPR).

The composition may comprise up to 15 wt %, preferably up to 10 wt %, and in particular up to 5 wt % of the biopesticide, biostimulant, and/or biofertilizer g). The composition may comprise from 0.01 to 15 wt %, preferably from 0.02 to 10 wt %, and in particular from 0.05 to 5 wt % of the biopesticide, biostimulant, and/or biofertilizer g).

The composition according to the invention is preferably essentially free of organic or inorganic thickener. The composition of the present invention contains preferably less than 0.05 wt %, more preferably less than 0.01 wt % of organic or inorganic thickener.

The composition according to the invention comprises no organic or inorganic thickener.

Inorganic thickeners according to the invention are preferably selected from clays, that can also be organically modified, such as montmorillonite, bentonite, sepiolite, attapulgite, laponite and/or hectorite; and/or from fumed or precipitated silica particles, that can be hydrophilic or hydrophobic.

Organic thickeners according to the invention are preferably selected from hydrogenated vegetable oils or waxes, especially hydrogenated castor oil or wax, polypeptides or polysaccharides, especially from xanthan gum, guar gum and/or hydroxyethyl cellulose, or any other polymeric structurants, especially high molecular weight lipophilic polymers, such as polyester co-polymers or polyamides, that are known to be suitable as rheology modifiers.

Thickeners by way of example are
Polysaccharides including xanthan gum, guar gum and hydroxyethyl cellulose. Examples are Kelzan®, Rhodopol® G and 23, Satiaxane® CX911 and Natrosol® 250 range.
Clays including montmorillonite, bentonite, sepiolite, attapulgite, laponite, hectorite. Examples are Veegum® R, Van Gel® B, Bentone® CT, HC, EW, Pangel® M100, M200, M300, S, M, W, Attagel® 50, Laponite® RD.
Fumed or precipitated hydrophylic silica, examples are Aerosil® 200, Aerosil® 380, Sipernat® 22.
Fumed or precipitated hydrophobic silica, examples are Aerosil® R812, Aerosil® R812S, Aerosil® R972
Polymeric structurants, examples are Atlox Rheostrux® 100 (Polyester Co-Polymer), Atlox Rheostrux® 200 (Polyamide)
Hydrogenated vegetable oil or wax, especially hydrogenated castor oil or wax, such as Rheocin®.

In one embodiment of the invention the composition according to the invention comprises no hydrogenated castor oil or wax.

In a special embodiment of the present invention the liquid non-aqueous composition comprises
a) fosetyl-aluminium or fosetyl-sodium,
b) one or more water soluble solvents,
c) one or more surfactants,
d) one or more organic or inorganic colorants.

In a preferred embodiment of the present invention the liquid non-aqueous composition comprises
a) fosetyl-aluminium or fosetyl-sodium,
b) a water soluble solvent,
c) a surfactant,
d) an organic or inorganic colorant,
e) optionally a further active ingredient,
f) a further formulation additive and
g) optionally a biopesticide, biostimulant, and/or biofertilizer.

In a more preferred embodiment of the present invention the liquid non-aqueous composition comprises or consists of
a) fosetyl-aluminium or fosetyl-sodium,
b) one or more water soluble solvents,
c) one or more surfactants,
d) one or more organic or inorganic colorants,
e) optionally one or more further active ingredients,
f) one or more further formulation additives and
g) optionally one or more biopesticide, biostimulant, and/or biofertilizer.

In an even more preferred embodiment of the present invention the liquid non-aqueous composition comprises or consists of
a) fosetyl-aluminium or fosetyl-sodium,
b) one or more water soluble solvents, selected from the alcohols or ethers according to formula (I),

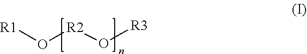

wherein
R¹ and R³ are independently of each other selected from H or (C₁-C₄)alkyl,
R² is selected from (C₂-C₄)alkyl and
n is 1 to 5, preferably n is 1 to 2, or further from propylene carbonate, dipropylene carbonate, butylene carbonate, dibutylene carbonate or glycerine;
c) one or more surfactants, selected from alkali, alkaline earth and ammonium salts of
   arylsulfonates, especially dodecylbenzenesulfonates,
   salts of aryl polyethoxylated and/or polypropoxylated sulfates, especially polyethoxylated and/or polypropoxylated polyarylphenol sulfates,
   naphthalenesulfonic acid or alkyl naphtalenesulfonic acid,
   formaldehyde condensation products of naphthalenesulfonic acid or alkyl naphtalenesulfonic acid or
   sulfonates of condensed naphtalenes or alkyl napthtalenes,
or further from
   end group-capped and non-end group-capped polycondensates of ethylene oxide and/or propylene oxide with linear or branched, saturated or unsaturated alcohols,
   polyoxyethylene fatty acid esters or
   polycondensates of ethylene oxide and/or propylene oxide with phenols or substituted phenols;
d) one or more organic or inorganic colorants, selected from anthraquinone-, pyrrole- and metal phthalocyanine colorants or naphthol AS-based colorants;
f) one or more further formulation additives, selected from anti-foaming agents, humectants, stabilizers or pH-adjusters; and
g) optionally one or more biopesticide, biostimulant, and/or biofertilizer.

In an especially preferred embodiment of the present invention the liquid non-aqueous composition comprises or consists of
a) fosetyl-aluminium,
b) one or more water soluble solvents, selected from glycerine, propylene glycol methyl ether, dipropylene glycol methyl ether and/or tripropylene glycol methyl ether,
c) one or more surfactants, selected from the sodium salt of naphthalene or alkyl naphthalene sulfonate condensates with formaldehyde,
   ethoxylated tristyrylphenol with 16 to 80 EO groups,
   or ethoxy- and propoxylated linear or branched alcohols, particularly preferred butoxy polyethylene-polypropylene glycols;
d) one or more organic or inorganic colorants, selected from metal-phthalocyanine, diketo pyrrolo pyrrole and water soluble anthraquinone colorants or naphthol AS-based colorants;
f) one or more further formulation additives, selected from anti-foaming agents;
g) optionally one or more biopesticide, biostimulant, and/or biofertilizer.

The proportion of the fosetyl-aluminium or fosetyl-sodium compound a) in the compositions according to the invention is 20 to 60 wt %,
preferably 35 to 55 wt %,
more preferably 36 to 49 wt %, and
most preferred 38 to 48 wt %.

The proportion of water soluble solvent(s) b) in the compositions according to the invention is preferably 20 to 79.5 wt %,
more preferably 25 to 64.5 wt %, and
most preferred 30 to 63.5 wt %.

The proportion of surfactant(s) c) in the compositions according to the invention is
preferably 0.01 to 20 wt %,
more preferably 0.05 to 15 wt %, and
most preferred 0.1 to 10 wt %.

The proportion of colorant(s) d) in the compositions according to the invention is
preferably 0.1 to 15 wt %,
more preferably 0.5 to 10 wt %, and
most preferred 1 to 5 wt %.

The proportion of further active ingredient(s) e)—if present—in the compositions is
preferably 0.1 to 60 wt %,
more preferably 0.5 to 40 wt %, and
most preferred 1 to 20 wt %.

The proportion of further formulation additive(s) f) in the compositions according to the invention is
preferably 0.01 to 15 wt %,
more preferably 0.02 to 10 wt %, and
most preferred 0.05 to 5 wt %.

The proportion of biopesticide, biostimulant, and/or biofertilizer g)—if present—in the compositions according to the invention is
preferably 0.01 to 15 wt %,
more preferably 0.02 to 10 wt %, and
most preferred 0.05 to 5 wt %.

A preferred embodiment of the invention is a composition comprising components
a) 20-60 wt %,
b) 20-79.5 wt %,
c) 0.01-20.5 wt %,
d) 0.1-15 wt % (if present),
e) 0.1-60 wt % (if present),
f) 0.01-15 wt % and
g) 0.01-15 wt % (if present).

A more preferred embodiment of the invention is a composition comprising components
a) 35-55 wt %,
b) 25-64.5 wt %,
c) 0.05-15 wt %,
d) 0.5-10 wt % (if present),
e) 0.5-40 wt % (if present),
f) 0.02-10 wt % and
g) 0.02-10 wt % (if present).

A even more preferred embodiment of the invention is a composition comprising components
a) 36-49 wt %,
b) 30-63.5 wt %,
c) 0.1-10 wt %,
d) 1-5 wt % (if present),
e) 1-20 wt % (if present),
f) 0.05-5 wt % and
g) 0.05-5 wt % (if present).

In a preferred embodiment of the present invention the liquid non-aqueous composition comprises
a) 20 to 60 wt % fosetyl-aluminium or fosetyl-sodium,
b) 20 to 79.5 wt % water soluble solvent,
c) 0.01 to 20 wt % surfactant,
d) 0.1 to 15 wt % organic or inorganic colorant,
e) optionally 0.1 to 60 wt % further active ingredient,
f) 0.01 to 15 wt % further formulation additive and
g) optionally 0.01 to 15 wt % biopesticide, biostimulant, and/or biofertilizer.

In a more preferred embodiment of the present invention the liquid non-aqueous composition comprises or consists of
a) 20 to 60 wt % fosetyl-aluminium or fosetyl-sodium,
b) 20 to 79.5 wt % of one or more water soluble solvents,
c) 0.01 to 20 wt % of one or more surfactants,
d) 0.1 to 15 wt % of one or more organic or inorganic colorants,
e) optionally 0.1 to 60 wt % of one or more further active ingredients,
f) 0.01 to 15 wt % of one or more further formulation additives and
g) optionally 0.01 to 15 wt % one or more biopesticide, biostimulant, and/or biofertilizer.

In an even more preferred embodiment of the present invention the liquid non-aqueous composition comprises or consists of
a) 35 to 55 wt % fosetyl-aluminium or fosetyl-sodium,
b) 25 to 64.5 wt % of one or more water soluble solvents, selected from the alcohols or ethers according to formula (I),

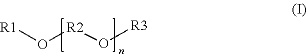

wherein
R¹ and R³ are independently of each other selected from H or (C₁-C₄)alkyl,
R² is selected from (C₂-C₄)alkyl and
n is 1 to 5, preferably n is 1 to 2,
or further from propylene carbonate, dipropylene carbonate, butylene carbonate, dibutylene carbonate or glycerine;
c) 0.05 to 15 wt % of one or more surfactants, selected from alkali, alkaline earth and ammonium salts of
   arylsulfonates, especially dodecylbenzenesulfonates,
   salts of aryl polyethoxylated and/or polypropoxylated sulfates, especially polyethoxylated and/or polypropoxylated polyarylphenol sulfates,
   naphthalenesulfonic acid or alkyl naphtalenesulfonic acid,
   formaldehyde condensation products of naphthalenesulfonic acid or alkyl naphtalenesulfonic acid or
   sulfonates of condensed naphtalenes or alkyl napthtalenes,
or further from
   end group-capped and non-end group-capped polycondensates of ethylene oxide and/or propylene oxide with linear or branched, saturated or unsaturated alcohols,
   polyoxyethylene fatty acid esters or
   polycondensates of ethylene oxide and/or propylene oxide with phenols or substituted phenols;
d) 0.5 to 10 wt % of one or more organic or inorganic colorants, selected from anthraquinone-, pyrrole- and metal phthalocyanine colorants or naphthol AS-based colorants;
f) 0.02 to 10 wt % of one or more further formulation additives, selected from anti-foaming agents, humectants, stabilizers or pH-adjusters; and
g) optionally 0.02 to 10 wt % of one or more biopesticide, biostimulant, and/or biofertilizer.

In an especially preferred embodiment of the present invention the liquid non-aqueous composition comprises or consists of
a) 36 to 49 wt % fosetyl-aluminium,
b) 30 to 63.5 wt % of one or more water soluble solvents, selected from glycerine, propylene glycol methyl ether, dipropylene glycole methyl ether and/or tripropylene glycol methyl ether;
c) 0.1 to 15 wt % of one or more surfactants, selected from the sodium salt of naphthalene or alkyl naphthalene sulfonate condensates with formaldehyde,
   ethoxylated tristyrylphenol with 16 to 80 EO groups,
   or end-group capped ethoxy- and propoxylated linear or branched alcohols, particularly preferred butoxy polyethylene-polypropylene glycols,
d) 1 to 5 wt % of one or more organic or inorganic colorants, selected from metal-phthalocyanine, diketo pyrrolo pyrrole and water soluble anthraquinone colorants or naphthol AS-based colorants;
f) 0.05 to 5 wt % of one or more further formulation additives, selected from anti-foaming agents;
g) optionally 0.05 to 5 wt % of one or more biopesticide, biostimulant, and/or biofertilizer.

Further claimed is a process for preparing the composition according to the invention by mixing or wet milling components a) to d) and f) and optionally components e) and g).

Further claimed is a process for preparing the composition according to the invention by mixing and/or wet milling components a) to d) and f) and optionally components e) and g).

Further claimed is a process for preparing the composition according to the invention by mixing and/or wet milling components a) to d) and f) and optionally component g).

The mixing may be done by Ultra-Turrax or high shear equipment.

The active ingredient compound a) can be initially used as micronized active ingredient or can be micronized via for example jet or bead milling during the preparation process.

Within this process the active ingredient compound a) can be used as micronized solid. When micronized AI is used the composition according to the invention can be prepared by Ultra-Turrax or high shear equipment.

In a further preferred embodiment, the components a) to d) and f) and optionally components e) and g) are wet milled together to obtain the final composition. Preferably the components are wet milled until the particle size distribution D90 of the particles in the composition is from 10 to 40 μm, preferably from 14 to 30 μm and more preferred from 15 to 25 μm and most preferred from 15 to 20 μm.

Wet-milling is a standard technology, known in the art. Briefly, a pre-homogenized mixture with a coarse particle size distribution is passed through a cooled bead mill (for example, a DYNO®-mill, WAB GROUP®), until a particle size distribution within the target range (e.g. D90) is obtained.

Further claimed is a method of controlling harmful organisms, comprising the contacting of the harmful organisms, their habitat, their hosts, such as plants and seed, and the soil, the area and the environment in which they grow or could grow, but also of materials, plants, seeds, soil, surfaces or spaces which are to be protected from attack or infestation by organisms that are harmful to plants, with an effective amount of the compositions according to the invention.

Further claimed is the use of the composition according to the invention for protection of plants including seed, in particular useful plants, from infestation by harmful organisms.

Further claimed is the use of the composition according to the invention for control of organisms that are harmful to plants, such as phytopathogenic harmful fungi.

The present disclosure further provides methods for preventing or reducing fungal infestation of a plant or crop. In certain embodiments, the methods for preventing or reducing fungal infestation of a plant or crop may include applying fosetyl-aluminum and/or fosetyl-sodium, or agrochemically-acceptable salts thereof, to the plant or crop. In certain embodiments, the methods for preventing or reducing fungal infestation of a plant or crop may include applying any one of the presently disclosed fosetyl-aluminum and/or fosetyl-sodium compositions or formulations to the plant or crop. The presently disclosed compositions and methods may be applied to healthy or diseased plants and crops. In certain embodiments, the presently disclosed methods and compositions may be used prophylactically to treat healthy or substantially healthy plants and crops in order to prevent or reduce the risk of fungal infestation of the plant or crop. In certain embodiments, the plant or crop may include turfgrass, ornamental grass, an ornamental plant, or any combination thereof.

The present disclosure further provides methods for enhancing turf quality or for enhancing the quality of ornamental plants. As used herein, the term “turf,” in all of its forms refers to a stand of turfgrass, including, but not limited to, the well-preserved, well-maintained, cultivated, or mowed turfgrass used in golf courses, sports fields, scenic areas, parks, home lawns, gardens, and the like. Enhanced or improved turf quality may be manifested in numerous ways, including, but not limited to, improved visual quality, improved visual color, improved green color, improved turf coverage or fill, improved turfgrass density, improved turfgrass color density, improved greenness, improved wear or resistance to physical and mechanical damage due to animal or vehicular traffic, and improved turfgrass uniformity. Enhanced ornamental plant quality may be manifested in numerous ways, including, but not limited to, improved visual quality, improved visual color, improved greenness or color, increased plant cell turgidity, and sturdier plant structure. In certain embodiments, the methods for enhancing turf quality or for enhancing the quality of ornamental plants may include applying fosetyl-aluminum and/or fosetyl-sodium, or agrochemically-acceptable salts, formulations, or compositions thereof, to the turf or ornamental plant. In some embodiments, the methods for enhancing turf quality or for enhancing the quality of ornamental plants may include applying to the turf or ornamental plant any one of the presently disclosed fosetyl-aluminum and/or fosetyl-sodium compositions or formulations thereof. The presently disclosed fosetyl-aluminum and/or fosetyl-sodium compositions and formulations may be applied to healthy or diseased turf or ornamental plants. In certain embodiments, the presently disclosed methods and compositions may be used prophylactically to treat healthy or substantially healthy turf or ornamental plants in order to enhance the quality of the turf or ornamental plants.

Turfgrass may include any grasses that may be used in lawns, golf courses, sports fields, commercial recreational and landscaped areas, institutional and municipal recreational and landscaped areas, sod farms, and the like. In some embodiments, the turfgrass may be mowed turfgrass. In certain embodiments, the turfgrass may be a warm season turfgrass or a cool season turfgrass. Non-limiting examples of turfgrasses may include, for example, creeping bent grass (Agrostis stoloniferas), common bermudagrass (Cynodon dactylon), hybrid bermudagrass (Cynodon dactylon x Cynodon transvaalensis), zoysiagrasses (Zoysia japonica, Zoysia matrella, Zoysia tenuifolia), St. Augustine grass (Stenotaphrum secundatum), centipede grass (Eremochloa ophiuroides), bahiagrass (Paspalum notatum), buffalograss (Bouteloua dactyloides), tall fescue (Festuca arundinacae), fine fescues (Festuca rubra, Festuca ovina, Festuca brevipila), perennial ryegrass (Lolium perenne), annual ryegrass (Lolium perennis), Kentucky bluegrass (Poa pratensis), annual bluegrass (Poa annua), rough bluegrass (Poa trivialis), colonial bent grass (Agrostis capillaris), and other Poa species of grasses, Bermuda grass, and Rye grass.

Non-limiting examples of cool season turfgrasses may include, for example, bluegrasses (Poa spp.), such as Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), and bulbous bluegrass (Poa bulbosa L.); the bentgrasses and redtop (Agrostis spp.), such as creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., and Agrostis palustris Huds.), and redtop (Agrostis alba L.); the fescues (Festucu spp.), such as red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.); the ryegrasses (Lolium spp.), such as annual ryegrass (Lolium multiflorum Lam.), perennial ryegrass (Lolium perenne L.), italian ryegrass (Lolium multiflorum Lam.); and the wheatgrasses (Agropyron spp.), such as fairway wheatgrass (Agropyron cristatum (L.) Gaertn.), crested wheatgrass (Agropyron desertorum (Fisch.) Schult.), and western wheatgrass (Agropyron smithii Rydb.), beachgrass (Ammophila breviligulata Fern.), smooth bromegrass (Bromus inermis Leyss.), cattails such as Timothy (Phleum pratense L.), sand cattail (Phleum subulatum L.), orchardgrass (Dactylis glomerata L.), weeping alkaligrass (Puccinellia distans (L.) Parl.) and crested dog's-tail (Cynosurus cristatus L.).

Non-limiting examples of warm season turfgrasses may include, for example, Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz) and sideoats grama (Bouteloua curtipendula (Michx. Torr.).

Non-limiting examples of ornamental grasses may include, for example, sedges (Cyperaceae), rushes (Juncaceae), restios (Restionaceae), and cat-tails (Typhaceae). Other non-limiting examples of ornamental grasses may include, for example, Andropogon gerardii, Miscanthus sinensis ‘Gracillimus’, Muhlenbergia capillaris, Panicum virgatum ‘Shenandoah, Schizachyrium scoparium, and Calamagrostisxacutiflora, autumn moor grass (Sesleria species), blue oat grass (Helictotrichon species), tufted hair grass (Deschampsia species), fescue grass (Festuca species), northern sea oats (Chasmanthium latifolium), fountain grass (Pennisetum species), and switch grass (Panicum species), little blue stem (Schizachyrium scoparium), needle grass (Stipa spartea), june grass (Koeleria macrantha) and western wheatgrass (Agropyron smithii), tufted hair grass, northern sea oats, switch grass, Miscanthus species and Calamagrostis species, little bluestem grass, love grass (Eragrostis species), blue oat grass, tufted hair grass and Calmagrostis species, blue lyme grass (Leymus arenarius), strawberry and cream grass (Phalaris arundinacea) and cord grass (Spartina species).

Ornamental plants may include any plants that are commonly grown for ornamental or landscaping purposes, including, but not limited to, non-crop plants that may be grown or cultivated in plant nurseries or commercial growing environments. Ornamental plants may include plants that are potted or grown in containers, for example, in a plant nursery, or ornamental plants that may be planted in the ground, for example, in a landscaped or cultivated growing environment. Ornamental plants may include, but is not limited to, herbaceous plants, annual shrubs, perennial shrubs, and woody plants such as shrubs and trees. Additional non-limiting examples of ornamental plants may include, for example, Aglaonema, Aphelandra, Azalea, Bougainvillea, Boxwood, Cattelya skinneri, Cissus, Dieffenbachia, Hibiscus, Juniper, Leather-lead Fern, Pittosporum, Philodendron, Pothos, Rhododendron, Spathiphyllum, Taxus media, Japanese Holly, Monterey Pine, Pieris, Schefflera, Begonia, Pansy, Vinca, Marigold, Zinnia, Petunia, Geranium, Impatiens, Douglas Firs, Spruce, Pines, Ornamental Pear, Pyracantha, Hawthorn, English Ivy, Anthurium, Syngonium, and Ficus.

The application rate of the compositions according to the invention can be varied within relatively wide ranges. The application rates may be guided by the respective active ingredients used, the particular formulation used, and by the content of the compositions. In certain embodiments, the application rate used in the presently disclosed methods may be from about 1 kilogram (kg) active ingredient (a.i.) per hectare (ha) to about 20 kg a.i./ha per each application, where the active ingredient is fosetyl-aluminum, fosetyl-sodium, or any agrochemically-acceptable salt thereof. In other embodiments, the application rate may be from about 1 kg to about 15 kg a.i./ha, or from about 3 kg to about 13 kg a.i./ha, or from about 3.5 kg to about 12 kg a.i./ha, or from about 3.5 kg to about 11 kg a.i./ha, or from about 3.6 kg to about 11.0 kg a.i./ha per each application. The presently disclosed compositions may be applied once per year or numerous times per year depending on the plant or crop that may be treated. When applied to turf, the presently disclosed compositions may be applied many times throughout the year or throughout the growing season. For example, the presently disclosed compositions and formulations may be applied to turf or turfgrass such that the turf or turfgrass receives from eight (8) to twelve (12) applications per year.

With the aid of the compositions according to the invention, the fungicidal active ingredients can be deployed in a particularly advantageous manner on plants and/or their habitat.

The compositions according to the invention can be used to treat all plants and parts of plants. Plants in this context are understood to include all plants and plant populations, such as desired and unwanted wild plants or crop plants (including naturally occurring crop plants). Crop plants may be plants which can be obtained by conventional breeding and optimization methods or by biotechnological and genetic engineering methods or combinations of these methods, including the transgenic plants and including the plant cultivars which are protectable or non-protectable by plant breeders' rights. Parts of plants shall be understood to mean all parts and organs of the plants above and below ground, such as shoot, leaf, flower and root, examples given being leaves, needles, stalks, stems, flowers, fruit bodies, fruits and seeds, and also tubers, roots and rhizomes. Plant parts also include harvested material and vegetative and generative propagation material, for example cuttings, tubers, rhizomes, shoots and seeds.

Preferably, the compositions according to the invention are used by spray application against fungus.

The inventive treatment of the plants and parts of plants with the compositions according to the invention is effected directly or by allowing the compositions to act on their surroundings, environment or storage space by the customary treatment methods, for example by drenching, immersion, spraying, evaporation, fogging, scattering, painting on and, in the case of propagation material, in particular in the case of seeds, also by applying one or more coats.

Preferably, the plant to be treated is selected from the group consisting of turf or horticultural crops such as cotton, soya beans, tobacco, vegetables, spices, ornamental plants, conifers, citrus plants, fruit, pomefruit, tropical crops, nuts, avocado, durian and grapevines.

Fosetyl mode of action and treated fungal pests are described in “The pesticide Manual, 16th edition, C. MacBean, 2012 BCPC. Finally, it has been found that the compositions according to the invention are of very good suitability for application of the active agrochemical ingredients present to plants and/or the habitat thereof.

The examples which follow illustrate the subject-matter of the invention without limiting it.

### EXAMPLES

Materials used in the examples:

| | | Manufacturer/ | |
|---|---|---|---|
| Trade name | CAS No. | supplier | Chemical name |
| Antarox B/848 | 9038-95-3 | Solvay | Alkyl propoxylate ethoxylate MW |
| | | | 2600, 48% EO |
| Lucramul PS54 | 104376- | Levaco | Tristyrylphenolpolyethyleneglycolether |
| | 75-2 | | |
| Morwet D-425 | 68425-94- | Akzo Nobel | Condensed naphthalene formaldehyde |
| | 5 | | sulfonate, sodium salt |
| Silfoam SC 1132 | 63148-62- | Wacker | Dimethyl siloxanes and silicones |
| | 9 | | |
| Glycerine | 56-81-5 | various | 1,2,3 propanetriol |
| Dowanol DPM | 34590-94- | Dow | Dipropylene Glycolmethylether |
| | 8 | | |
| Green Pigment | | | Cu-phthalocyanine, chlorinated |
| Red Pigment 1 | | | Diketo pyrrol pyrrole |
| Red Pigment 2 | | | naphthol AS-based |
| Green Dye | | | Anthraquinone dye |
| Aerosil 200 | 112945- | Evonik | Hydrophilic fumed silica with a |
| | 52-5 | | specific surface area of 200 m²/g |

### Methods

All tests were done according to the plant growth typical regulations: CIPAC methods as below. (CIPAC=Collaborative International Pesticides Analytical Council; www.cipac.org).

### Particle Size

The particle size is determined according to CIPAC (CIPAC=Collaborative International Pesticides Analytical Council; www.cipac.org) method MT 187. The particle size distribution is determined by means of laser diffraction. A representative amount of sample is dispersed in degassed water at ambient temperature (self-saturation of the sample), treated with ultrasound (usually 60 s) and then measured in a device from the Malvern Mastersizer series (Malvern Panalytical). The scattered light is measured at various angles using a multi-element detector and the associated numerical values are recorded. With the help of the Fraunhofer model, the proportion of certain size classes is calculated from the scatter data and from this a volume-weighted particle size distribution is calculated. Usually, the D50 or D90 value=active ingredient particle size (50 or 90% of all volume particles) is given.

### Rotational Viscosity

Rotational Viscosity is measured according to CIPAC MT 192. Stable and convenient formulations are expected to exhibit medium-ranged viscosities in order to allow for convenient bottle emptying and cleaning.

### Phase Separation/Syneresis

Phase separation directly after storage is reported either as sediment fraction and calculated from the quotient H1 [level of the interface layer between sediment phase and supernatant] divided by H0 [total fill height of the sample] or, as in the present case, as supernatant fraction:

Sediment fraction=(H1/H0)*100[%] or

Supernatant fraction=100−sediment content [%]

Stable and convenient formulations are expected to exhibit no or only little phase separation upon storage at elevated temperatures for a prolonged period of time and are easily rehomogenized. Marked phase separation after a short storage time indicates limited storage stability and a significant tendency to formation of sediments that are dispersible only with difficulty, if at all, during storage.

### Fosetyl-Aluminium (FEA) Content by HPLC (High Performance Liquid Chromatography)-UV/Vis:

The active substance FEA is separated from formulation components on a reversed phase column using isocratic elution. After UV detection, the quantitative evaluation is carried out by comparing the peak areas with those of reference items, using a single-point calibration or a standard curve.

HPLC: Agilent 1260 LC system; Column: Phenomenex Luna C18(2) 150×4.6 mm; eluent A: 1.3 mM phthalic acid+0.5 mM TBA (Tetrabutylammonium) pH 8.5/acetonitrile 95/5 (v/v); eluent B: none; oven temperature 30° C.; flow rate: 1.0 ml/min; injection volume 10 μl;
Detection conditions: Measurement wavelength 550 nm; Detector: Agilent 1260, DAD or VWD;
Integration and evaluation: Thermo Fisher Chromeleon V7.2.

### Sediment in Bottle and Redispersibility

After 3 slow inversions of bottle, pouring the supernatant out of the bottle, visually inspecting the remaining formulation at the bottom of the bottle and filling bottle with water 20% of bottle volume followed by 10 slow inversions and doing the aforementioned redispersing 4-times (3 times for example 5)
→grading:
“+” homogenous free flowing before addition of water, easily redispersible after addition of water;
“O” some stickiness of leftover before addition of water but easily dispersible with water;
“−” sticky leftover and not fully redispersible.

The hereafter described formulation is characterized by active particles dispersed in a water-miscible solvent. Manufacturing process is largely similar to the production of suspension concentrates or oil dispersions. Methods for preparation of suspension concentrate formulations or oil dispersions are known in the art and can be produced by known methods familiar to those skilled in the art.

### Example 1

Formulation components (A), micronized active ingredient (air jet milled, D50≤15 μm; D90≤ 30 μm) (B) and colorant (C) are weighed in, and mixed in with low shear stirring, followed by homogenization with a high-shear device (colloid mill) (e.g. Ultra-Turrax or Silverson) until a homogenous mixture is achieved. The mixing was facilitated by raising the temperature slightly (not exceeding 50° C.).

| | Order | Recipe according to |
|---|---|---|
| Component | of addition | the invention (wt %) |
| Fosetyl-aluminium | (B) | 43.5 |
| (air jet milled, | | |
| D90 ~20-30 μm) | | |
| Green Pigment | (C) | 2.5 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 39.9 |

### Results

| | | 2 Weeks | 8 Weeks | |
|---|---|---|---|---|
| Storage | 0 Days | 54 °C | 40 °C | Resume |
| FEA content | 43.89 | 43.45 | 43.21 | Very good |
| Syneresis | — | 3% | 4% | Very good |
| Particle size | 21 | 21 | 21 | Very good |
| (D90) in μm | | | | |
| Sediment in | + | + | + | Very good |
| bottle and | | | | |
| redispersibility | | | | |
| Viscosity | 1163/703/ | 1034/646/ | 1024/641/ | Very good |
| rotational @ | 431 | 407 | 405 | |
| 7.5 1/s; 20 1/s; | | | | |
| 100 1/s in mPas | | | | |

Example 1 shows after storage for 8.5 month at room temperature in a 51 container a syneresis of 21%. However, the composition could be rehomogenized by shaking.

### Example 2

### Preparation According to Example 1

| | | Recipe according |
|---|---|---|
| | Order | to the invention |
| Component | of addition | (wt %) |
| Fosetyl-aluminium | (B) | 43.5 |
| (air jet milled, | | |
| D90 ~20-30 μm) | | |
| Red pigment 1 | (C) | 2.5 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 39.9 |

### Results

| | | 2 Weeks | 8 Weeks | |
|---|---|---|---|---|
| Storage | 0 Days | 54 °C | 40 °C | Resume |
| FEA content | 43.39 | 43.11 | 43.25 | Very good |
| Syneresis | — | 10% | 10% | Very good |
| Particle size | 20 | 19 | 21 | Very good |
| (D90) in μm | | | | |
| Sediment in | + | + | + | Very good |
| bottle and | | | | |
| redispersibility | | | | |
| Viscosity | 749/464/ | 829/510/ | 875/536/ | Very good |
| rotational @ | 294 | 320 | 335 | |
| 7.5 1/s; 20 1/s; | | | | |
| 100 1/s in mPas | | | | |

### Example 3

### Preparation According to Example 1

| | | Recipe |
|---|---|---|
| | Order of | according to the |
| Component | addition | invention (wt %) |
| Fosetyl-aluminium | (B) | 43.5 |
| (air jet milled, | | |
| D90 ~20-30 μm) | | |
| Red Pigment 2 | (C) | 5.3 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 37.1 |

### Results

| | | 2 Weeks | 8 Weeks | |
|---|---|---|---|---|
| Storage | 0 days | 54 °C | 40 °C | Resume |
| FEA content | 41.8 | 41.3 | 42.3 | Very good |
| Syneresis | — | 5% | 9% | Very good |
| Particle size | 21 | 21 | 20 | Very good |
| (D90) in μm | | | | |
| Sediment in | + | + | + | Very good |
| bottle and | | | | |
| redispersibility | | | | |
| Viscosity | 1364/915/ | 1327/925/ | 1443/982/ | Very good |
| rotational @ | 655 | 678 | 712 | |
| 7.5 1/s; 20 1/s; | | | | |
| 100 1/s in mPas | | | | |

### Example 4 (Comparative without Colorant)

Preparation according to example 1 without addition of colorant (C).

| | | Recipe |
|---|---|---|
| | Order of | according to the |
| Component | addition | invention (wt %) |
| Fosetyl-aluminium | (B) | 42.9 |
| (air jet milled, | | |
| D90 ~20-30 μm) | | |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 40.5 |

### Results

| | | 2 Weeks | 8 Weeks | |
|---|---|---|---|---|
| Storage | 0 Days | 54 °C | 40 °C | Resume |
| FEA content | 43.39 | 43.57 | 42.43 | Very good |
| Syneresis | — | 13% | 17% | Very good |
| Particle size | 21 | 21 | 21 | Very good |
| (D90) in μm | | | | |
| Sediment in | + | + | + | Very good |
| bottle and | | | | |
| redispersibility | | | | |
| Viscosity | 445/306/ | 478/334/ | 379/268/ | Very good |
| rotational @ | 228 | 253 | 205 | |
| 7.5 1/s; 20 1/s; | | | | |
| 100 1/s in mPas | | | | |

Example 4 shows after storage for 8.5 month at room temperature in a 51 container a high syneresis of 29%. Even after strong shaking no homogeneous composition was obtained and there was still visible phase separation.

### Example 5

### Preparation According to Example 1

| | | Recipe |
|---|---|---|
| | Order of | according to the |
| Component | addition | invention (wt %) |
| Fosetyl-aluminium | (B) | 42.4 |
| (air jet milled, | | |
| D90 ~20-30 μm) | | |
| Green Pigment | (C) | 4.95 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 38.55 |

### Example 5a (Comparative Data with Thickener)

Preparation according to example 1. For the comparative example the thickener Aerosil 200 (D) is added in a subsequent final step and mixed until homogenous.

| | | Recipe |
|---|---|---|
| | Order of | according to the |
| Component | addition | prior art (wt %) |
| Fosetyl-aluminium | (B) | 42.4 |
| (air jet milled, | | |
| D90 ~20-30 μm) | | |
| Green Pigment | (C) | 4.95 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 37.55 |
| Aerosil 200 | (D) | 1.0 |

### Results

| | Example 5 | Example 5a |
|---|---|---|
| Viscosity | 2295/1353/760 | 6830/3451/1529 |
| rotational @ | | |
| 7.5 1/s; 20 1/s; | | |
| 100 1/s in mPas | | |
| measured after | | |
| preparation | | |
| (0 days) | | |

### Example 6

### Preparation According to Example 1

| | | Recipe |
|---|---|---|
| | Order of | according to the |
| Component | addition | invention (wt %) |
| Fosetyl-aluminium | (B) | 43.5 |
| (air jet milled, | | |
| D90 ~20-30 μm) | | |
| Green Dye | (C) | 2.1 |
| Antarox B/848 | (A) | 2 |
| Lucramul PS 54 | (A) | 1 |
| Morwet D-425 | (A) | 1 |
| Silfoam SC 1132 | (A) | 0.1 |
| Glycerine | (A) | 10 |
| Dowanol DPM | (A) | 40.3 |

### Results

| | | 2 Weeks | 8 Weeks | |
|---|---|---|---|---|
| Storage | 0 Days | 54 °C | 40 °C | Resume |
| FEA content | 43.39 | 42.03 | 43.33 | Very good |
| Syneresis | — | 8% | 9% | Very good |
| Particle size | 21 | 21 | 20 | Very good |
| (D90) in μm | | | | |
| Sediment in | + | + | + | Very good |
| bottle and | | | | |
| redispersibility | | | | |
| Viscosity | 667/449/ | 630/430/ | 658/439/ | Very good |
| rotational @ | 318 | 307 | 311 | |
| 7.5 1/s; 20 1/s; | | | | |
| 100 1/s | | | | |

### Example 7 and 7a (Comparative Data with Thickener)

Formulation components (A), micronized active ingredient (air jet milled, D50≤15 μm; D90≤30 μm) (B) and colorant (C) are weighed in, and mixed in with low shear stirring, followed by homogenization with a high-shear device (colloid mill; e.g. Ultra-Turrax or Silverson) until a homogenous mixture is obtained. The homogenous mixture is subsequently wet-milled (e.g. by ball-mill as known in the art) to achieve a final particle size≤25 μm (D90) (not exceeding 45° C.).

For the comparative data the thickener Aerosil 200 (D) was added together with the components (A), (B) and (C).

| | | Recipe 7 | |
|---|---|---|---|
| | | (according to | Recipe 7a |
| | Order of | the invention) | (comparative) |
| Component | addition | (wt %) | (wt %) |
| Fosetyl-aluminium | (B) | 42.4 | 42.4 |
| (air jet milled, | | | |
| D90 ~20-30 μm) | | | |
| Green Pigment | (C) | 2.5 | 2.5 |
| Antarox B/848 | (A) | 2 | 2 |
| Lucramul PS 54 | (A) | 1 | 1 |
| Morwet D-425 | (A) | 1 | 1 |
| Silfoam SC 1132 | (A) | 0.1 | 0.1 |
| Glycerine | (A) | 10 | 10 |
| Dowanol DPM | (A) | 41 | 40 |
| Aerosil 200 | (D) | — | 1 |

### Results

| | Example 7 | Example 7a |
|---|---|---|
| Viscosity | 1655/827/390 | 3412/1631/655 |
| rotational @ | | |
| 7.5 1/s; 20 1/s; | | |
| 100 1/s in mPas | | |
| measured after | | |
| preparation | | |
| (0 days) | | |

### Evaluation of the Experiments

The examples show that stable liquid non-aqueous composition of Fosetyl-Aluminium can be obtained without the addition of any inorganic or organic thickener. All examples show low syneresis and a very good behaviour regarding sedimentation in bottle and redispersibility.

The comparative data 5a and 7a show that the thickeners used according to the prior art (Aerosil 200, hydrophilic, fumed silica) in combination with Fosetyl-Aluminium result in a commercially unacceptable high viscosity which no longer allows for required spontaneous redispersion and convenient bottle emptying and cleaning.

The examples also show that the formulations containing colorants show an improved long term stability after 8.5 month compared to those without colorants (comparative example 4). Only the samples containing colorants can be properly rehomogenized by shaking.

### Statements of the Disclosure

Statement 1: A liquid non-aqueous composition comprising: a) fosetyl-aluminium and/or fosetyl-sodium, b) a water soluble solvent, c) a surfactant and d) an organic or inorganic colorant, wherein compound a) is present in an amount of 20 to 60 wt % and characterized in that the composition comprises no organic or inorganic thickener.

Statement 2: The composition according to Statement 1, wherein the organic or inorganic thickener is selected from the group consisting of natural clays, organically modified clays, montmorillonite, bentonite, sepiolite, attapulgite, laponite, hectorite, fumed silica particles, precipitated silica particles, hydrogenated vegetable oils, waxes, hydrogenated castor oil, polypeptides, polysaccharides, xanthan gum, guar gum, hydroxyethyl cellulose, high molecular weight lipophilic polymers, polyester co-polymers, polyamides, and any combination thereof.

Statement 3: The composition according to Statement 1 or Statement 2, characterized in that the colorant d) is selected from naphthol AS-based colorants, anthraquinone-, azo-, pyrrole- and metal phthalocyanine colorants, and combinations thereof.

Statement 4: The composition according to any one of Statements 1 to 3, characterized in that the water soluble solvent b) is selected from the alcohols or ethers according to formula (I),

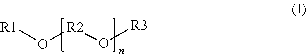

wherein R¹ and R³ are independently of each other selected from H or (C₁-C₄)alkyl, R² is selected from (C₂-C₄)alkyl and n is 1 to 5; further from propylene carbonate, dipropylene carbonate, butylene carbonate, dibutylene carbonate, glycerine or mixtures thereof.

Statement 5: The composition according to Statement 4, wherein n is 1 to 2.

Statement 6: The composition according to any one of Statements 1 to 5, comprising at least 20 wt % of water soluble solvents.

Statement 7: The composition according to any of Statements 1 to 6, characterized in that the composition comprises less than 30 wt % of glycerine.

Statement 8: The composition according to any one of Statements 1 to 6, characterized in that the composition comprises less than 20 wt % glycerine.

Statement 9: The composition according to any one of Statements 1 to 8, comprising less than 2 wt % of water.

Statement 10: The composition according to any one of Statements 1 to 9, characterized in that compound a) is present in the composition in the form of suspended particles with a particle size distribution D90 from 10 to 40 μm.

Statement 11: The composition according to any one of Statements 1 to 9, characterized in that compound a) is present in the composition in the form of suspended particles with a particle size distribution D90 from 14 to 30 μm.

Statement 12: The composition according to any one of Statements 1 to 9, characterized in that compound a) is present in the composition in the form of suspended particles with a particle size distribution D90 from 15 to 25 μm.

Statement 13: The composition according to any one of Statements 1 to 12, wherein the composition excludes a hydrogenated castor oil or wax.

Statement 14: The composition according to any one of Statements 1 to 12, wherein the composition does not comprise a hydrogenated castor oil or wax.

Statement 15: The composition according to any one of Statements 1 to 14, wherein the surfactant is selected from alkali, alkaline earth and ammonium salts of arylsulfonates, especially dodecylbenzenesulfonates, aryl polyethoxylated and/or polypropoxylated sulfates, especially polyethoxylated and/or polypropoxylated polyarylphenol sulfates, naphthalenesulfonic acid or alkyl naphtalenesulfonic acid, formaldehyde condensation products of naphthalenesulfonic acid or alkyl naphtalenesulfonic acid or sulfonates of condensed naphtalenes or alkyl napthtalenes, or further from end group-capped and non-end group-capped polycondensates of ethylene oxide and/or propylene oxide with linear or branched, saturated or unsaturated alcohols, polyoxyethylene fatty acid esters or polycondensates of ethylene oxide and/or propylene oxide with phenols or substituted phenols.

Statement 16: The composition according to any of Statements 1 to 15, characterized in that compound a) is present in an amount of 35 to 55 wt %.

Statement 17: The composition according to any of Statements 1 to 16, characterized in that compound a) is present in an amount of 36 to 49 wt %.

Statement 18: The composition according to any of Statements 1 to 17, characterized in that it comprises a further active ingredient e).

Statement 19: The composition according to any one of Statements 1 to 18, characterized in that it comprises f) a further formulation additives selected from anti-foaming agents, humectants, stabilizers or pH-adjusters, preferably from anti-foaming agents.

Statement 20: The composition according to any one of Statements 1 to 19, characterized in that it comprises a biopesticide, biostimulant, and/or biofertilizer g).

Statement 21: The composition according to any one of Statements 1 to 20, wherein the organic or inorganic colorant comprises a pigment, dye, or any combination thereof.

Statement 22: The composition according to any one of Statements 1 to 21, wherein the organic or inorganic colorant comprises a white, red, blue, or green pigment or dye.

Statement 23: The composition according to any one of Statements 1 to 21, wherein the organic or inorganic colorant absorbs light in the range from 280 and 2500 nm.

Statement 24: The composition according to any one of Statements 1-23, wherein the composition excludes an organic or inorganic thickener.

Statement 25: The composition according to any of Statements 1-15 or 18-24, characterized in that compound a) is present in an amount of 35 to 55 wt %.

Statement 26: The composition according to any of Statements 1-15 to 18-24, characterized in that compound a) is present in an amount of 36 to 49 wt %.

Statement 27: The composition according to any one of Statements 1-26, comprising at least 25 wt % water soluble solvent.

Statement 28: The composition according to any one of Statements 1-26, comprising at least 30 wt % water soluble solvent.

Statement 29: The composition according to any one of Statements 1-26, comprising at least 35 wt % water soluble solvent.

Statement 30: The composition according to any one of Statements 1-26, comprising at least 40 wt % water soluble solvent.

Statement 31: The composition according to any one of Statements 1-30, comprising from 20 wt % to 79.5 wt % water soluble solvent.

Statement 32: The composition according to any one of Statements 1-30, comprising from 25 wt % to 64.5 wt % water soluble solvent.

Statement 33: The composition according to any one of Statements 1-30, comprising from 30 wt % to 63.5 wt % water soluble solvent.

Statement 34: The composition according to any one of Statements 1-33, wherein the sum of the amounts of component b) water soluble solvent and component c) surfactants is at least 20 wt % based on the total weight of the composition.

Statement 35: The composition according to any one of Statements 1-33, wherein the sum of the amounts of component b) water soluble solvent and component c) surfactants is at least 30 wt % based on the total weight of the composition.

Statement 36: The composition according to any one of Statements 1-33, wherein the sum of the amounts of component b) water soluble solvent and component c) surfactants is at least 35 wt % based on the total weight of the composition.

Statement 37: The composition according to any one of Statements 1-33, wherein the sum of the amounts of component b) water soluble solvent and component c) surfactants is at least 40 wt % based on the total weight of the composition.

Statement 38: The composition according to any one of Statements 1-33, wherein the sum of the amounts of component b) water soluble solvent and component c) surfactants is at least 45 wt % based on the total weight of the composition.

Statement 39: The composition according to any one of Statements 1-33, wherein the sum of the amounts of component b) water soluble solvent and component c) surfactants is at least 50 wt % based on the total weight of the composition.

Statement 40: The composition according to any one of Statements 1-33, wherein the sum of the amounts of component b) water soluble solvent and component c) surfactants is at least 52 wt % based on the total weight of the composition.

Statement 41: The composition according to any one of Statements 1-33, wherein the sum of the amounts of component b) water soluble solvent and component c) surfactants is at least 54 wt % based on the total weight of the composition.

Statement 42: The composition according to any one of Statements 1-33, wherein the sum of the amounts of component b) water soluble solvent and component c) surfactants is at least 56 wt % based on the total weight of the composition.

Statement 43: The composition according to any one of Statements 1-33, wherein the sum of the amounts of component b) water soluble solvent and component c) surfactants is from 20 wt % to 85 wt % based on the total weight of the composition.

Statement 44: The composition according to any one of Statements 1-33, wherein the sum of the amounts of component b) water soluble solvent and component c) surfactants is from 25 wt % to 70 wt % based on the total weight of the composition.

Statement 45: The composition according to any one of Statements 1-33, wherein the sum of the amounts of component b) water soluble solvent and component c) surfactants is from 30 wt % to 68 wt % based on the total weight of the composition.

Statement 46: The composition according to any one of Statements 1-45, wherein the composition comprises up to 10 wt % of a water-insoluble organic solvent.

Statement 47: The composition according to any one of Statements 1-45, wherein the composition comprises up to 3 wt % of a water-insoluble organic solvent.

Statement 48: The composition according to any one of Statements 1-45, wherein the composition comprises up to 1 wt % of a water-insoluble organic solvent.

Statement 49: The composition according to any one of Statements 1-45, wherein the composition is substantially free of a water-insoluble organic solvent.

Statement 50: The composition according to any one of Statements 1-45, wherein the composition is substantially free of a water-insoluble organic solvent other than the recited components.

Statement 51: A process for preparing the composition according to any of Statements 1-50 by mixing or wet milling components a) to c) and optionally components d) to g).

Statement 52: The process according to Statement 51, further comprising mixing and/or wet milling components a) to d) and f), and, optionally, component g).

Statement 53: The process according to Statement 51 or Statement 52, wherein the mixing comprises mixing using Ultra-Turrax or high shear equipment.

Statement 54: Method of controlling harmful organisms, the method comprising the contacting of the harmful organisms, their habitat, their hosts, such as plants and seed, and the soil, the area and the environment in which they grow or could grow, but also of materials, plants, seeds, soil, surfaces or spaces which are to be protected from attack or infestation by organisms that are harmful to plants, with an effective amount of the compositions according to any one of Statements 1 to 50.

Statement 55: Use of the composition according to any of Statements 1 to 50 for protection of plants including seed, in particular useful plants, from infestation by harmful organisms.

Statement 56: Use of the composition according to any of Statements 1 to 50 for control of organisms that are harmful to plants, such as phytopathogenic harmful fungi.

Statement 57: A method for preventing or reducing fungal infestation of a plant or crop, the method comprising applying a composition according to any one of Statements 1 to 50 to the plant or crop.

Statement 58: A method for reducing the risk of a fungal infestation of a plant or crop, the method comprising applying a composition according to any one of Statements 1 to 50 to the plant or crop.

Statement 59: A method for treating a fungal infestation of a plant or crop, the method comprising applying a composition according to any one of Statements 1 to 50 to the plant or crop.

Statement 60: The method according to Statement 57 or Statement 58, further comprising prophylactically applying the composition to a healthy or substantially healthy plant or crop.

Statement 61: The method according to Statement 57 or Statement 59, further comprising applying the composition to a plant or crop suffering from one or more fungal diseases.

Statement 62: The method according to any one of Statements 57-61, wherein the plant or crop is selected from the group consisting of turfgrass, ornamental grass, an ornamental plant, and any combination thereof.

Statement 63: The method according to Statement 62, wherein the turfgrass comprises any grass or grasses that may be used in a lawn, golf course, sports field, commercial recreational area, commercial landscaped area, institutional or municipal recreational area, institutional or municipal landscaped area, or sod farm.

Statement 64: The method according to Statement 62 or Statement 63, wherein the turfgrass is mowed turfgrass.

Statement 65: The method according to any one of Statements 62-64, wherein the turfgrass is a warm season turfgrass.

Statement 66: The method according to any one of Statements 62-64, wherein the turfgrass is a cool season turfgrass.

Statement 67: The method according to any one of Statements 62-64, wherein the turfgrass is selected from the group consisting of creeping bent grass (Agrostis stoloniferas), common bermudagrass (Cynodon dactylon), hybrid bermudagrass (Cynodon dactylon x Cynodon transvaalensis), zoysiagrasses (Zoysia japonica, Zoysia matrella, Zoysia tenuifolia), St. Augustine grass (Stenotaphrum secundatum), centipede grass (Eremochloa ophiuroides), bahiagrass (Paspalum notatum), buffalograss (Bouteloua dactyloides), tall fescue (Festuca arundinacae), fine fescues (Festuca rubra, Festuca ovina, Festuca brevipila), perennial ryegrass (Lolium perenne), annual ryegrass (Lolium perennis), Kentucky bluegrass (Poa pratensis), annual bluegrass (Poa annua), rough bluegrass (Poa trivialis), colonial bent grass (Agrostis capillaris), other Poa species of grasses, Bermuda grass, Rye grass, and any combination thereof.

Statement 68: The method according to any one of Statements 62-64, wherein the turfgrass is a cool season turfgrass selected from the group consisting of bluegrasses (Poa spp.), Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), bulbous bluegrass (Poa bulbosa L.), bentgrasses and redtop (Agrostis spp.), creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., Agrostis palustris Huds.), redtop (Agrostis alba L.), fescues (Festucu spp.), red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.), ryegrasses (Lolium spp.), annual ryegrass (Lolium multiflorum Lam.), perennial ryegrass (Lolium perenne L.), italian ryegrass (Lolium multiflorum Lam.), wheatgrasses (Agropyron spp.), fairway wheatgrass (Agropyron Gaertn.), crested cristatum (L.) wheatgrass (Agropyron desertorum (Fisch.) Schult.), western wheatgrass (Agropyron smithii Rydb.), beachgrass (Ammophila breviligulata Fern.), smooth bromegrass (Bromus inermis Leyss.), cattails, Timothy (Phleum pratense L.), sand cattail (Phleum subulatum L.), orchardgrass (Dactylis glomerata L.), weeping alkaligrass (Puccinellia distans (L.) Parl.) crested dog's-tail (Cynosurus cristatus L.), and any combination thereof.

Statement 69: The method according to any one of Statements 62-64, wherein the turfgrass is a war season turfgrass selected from the group consisting of Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz), sideoats grama (Bouteloua curtipendula (Michx. Torr.), and any combination thereof.

Statement 70: The method according to any one of Statements 62-69, wherein the ornamental grass is selected from the group consisting of sedges (Cyperaceae), rushes (Juncaceae), restios (Restionaceae), cat-tails (Typhaceae), and any combination thereof.

Statement 71: The method according to any one of Statements 62-69, wherein the ornamental grass is selected from the group consisting of Andropogon gerardii, Miscanthus sinensis ‘Gracillimus’, Muhlenbergia capillaris, Panicum virgatum ‘Shenandoah, Schizachyrium scoparium, and Calamagrostisxacutiflora, autumn moor grass (Sesleria species), blue oat grass (Helictotrichon species), tufted hair grass (Deschampsia species), fescue grass (Festuca species), northern sea oats (Chasmanthium latifolium), fountain grass (Pennisetum species), and switch grass (Panicum species), little blue stem (Schizachyrium scoparium), needle grass (Stipa spartea), june grass (Koeleria macrantha) and western wheatgrass (Agropyron smithii), tufted hair grass, northern sea oats, switch grass, Miscanthus species and Calamagrostis species, little bluestem grass, love grass (Eragrostis species), blue oat grass, tufted hair grass and Calmagrostis species, blue lyme grass (Leymus arenarius), strawberry and cream grass (Phalaris arundinacea), cord grass (Spartina species), and any combination thereof.

Statement 72: The method according to any one of Statements 62-71, wherein the ornamental plant is any plant that is commonly grown for ornamental or landscaping purposes.

Statement 73: The method according to any one of Statements 62-72, wherein the ornamental plant is a non-crop plant that may be grown or cultivated in a plant nursery or commercial growing environment.

Statement 74: The method according to any one of Statements 62-73, wherein the ornamental plant is a potted ornamental plant.

Statement 75: The method according to any one of Statements 62-73, wherein the ornamental plant is a plant grown in a container.

Statement 76: The method according to any one of Statements 62-73, wherein the ornamental plant is a plant grown in the ground.

Statement 77: The method according to any one of Statements 62-76, wherein the ornamental plant is selected from the group consisting of herbaceous plants, annual shrubs, perennial shrubs, woody plants such as shrubs and trees, and any combination thereof.

Statement 78: The method according to any one of Statements 62-76, wherein the ornamental plant is selected from the group consisting of Aglaonema, Aphelandra, Azalea, Bougainvillea, Boxwood, Cattelya skinneri, Cissus, Dieffenbachia, Hibiscus, Juniper, Leather-lead Fern, Pittosporum, Philodendron, Pothos, Rhododendron, Spathiphyllum, Taxus media, Japanese Holly, Monterey Pine, Pieris, Schefflera, Begonia, Pansy, Vinca, Marigold, Zinnia, Petunia, Geranium, Impatiens, Douglas Firs, Spruce, Pines, Ornamental Pear, Pyracantha, Hawthorn, English Ivy, Anthurium, Syngonium, Ficus, and any combination thereof.

Statement 79: The method according to any one of Statements 57-78, wherein applying the composition according to any one of Statements 1 to 50 to the plant or crop comprises applying the composition at an application rate of from 1 kilogram (kg) active ingredient (a.i.) per hectare (ha) to 20 kg a.i./ha per each application, where the active ingredient is fosetyl-aluminum, fosetyl-sodium, or any agrochemically-acceptable salt thereof.

Statement 80: The method according to Statement 79, wherein the application rate is from 1 kg to 15 kg a.i./ha per each application.

Statement 81: The method according to Statement 79, wherein the application rate is from 3 kg to 13 kg a.i./ha per each application.

Statement 82: The method according to Statement 79, wherein the application rate is from 3.5 kg to 12 kg a.i./ha per each application.

Statement 83: The method according to Statement 79, wherein the application rate is from 3.5 kg to 11 kg a.i./ha per each application.

Statement 84: The method according to Statement 79, wherein the application rate is from 3.6 kg to 11.0 kg a.i./ha per each application.

Statement 85: A method for enhancing turf quality or for enhancing the quality of ornamental plants, the method comprising applying a composition according to any one of Statements 1 to 50 to the turf or ornamental plants.

Statement 86: The method according to Statement 85, wherein the turf comprises a stand of turfgrass.

Statement 87: The method according to Statement 85 or Statement 86, wherein enhancing turf quality comprises one or more selected from the group consisting of improved visual color, improved visual quality, improved green color, improved turf coverage or fill, improved turfgrass density, improved turfgrass color density, improved greenness, improved wear or resistance to physical and mechanical damage due to animal or vehicular traffic, improved turfgrass uniformity, and any combination thereof.

Statement 88: The method according to any one of Statements 85-87, wherein enhancing the quality of ornamental plants comprises one or more selected from the group consisting of improved visual quality, improved visual color, improved greenness, improved color, increased plant cell turgidity, sturdier plant structure, and any combination thereof.

Statement 89: The method according to any one of Statements 85-78, further comprising prophylactically applying the composition to healthy or substantially healthy turf or ornamental plants.

Statement 90: The method according to Statement 86 or Statement 87, wherein the turfgrass comprises any grass or grasses that may be used in a lawn, golf course, sports field, commercial recreational area, commercial landscaped area, institutional or municipal recreational area, institutional or municipal landscaped area, or sod farm.

Statement 91: The method according to Statement 86 or Statement 87, wherein the turfgrass is mowed turfgrass.

Statement 92: The method according to Statement 86 or Statement 87, wherein the turfgrass is a warm season turfgrass.

Statement 93: The method according to Statement 86 or Statement 87, wherein the turfgrass is a cool season turfgrass.

Statement 94: The method according to Statement 86 or Statement 87, wherein the turfgrass is selected from the group consisting of creeping bent grass (Agrostis stoloniferas), common bermudagrass (Cynodon dactylon), hybrid bermudagrass (Cynodon dactylon x Cynodon transvaalensis), zoysiagrasses (Zoysia japonica, Zoysia matrella, Zoysia tenuifolia), St. Augustine grass (Stenotaphrum secundatum), centipede grass (Eremochloa ophiuroides), bahiagrass (Paspalum notatum), buffalograss (Bouteloua dactyloides), tall fescue (Festuca arundinacae), fine fescues (Festuca rubra, Festuca ovina, Festuca brevipila), perennial ryegrass (Lolium perenne), annual ryegrass (Lolium perennis), Kentucky bluegrass (Poa pratensis), annual bluegrass (Poa annua), rough bluegrass (Poa trivialis), colonial bent grass (Agrostis capillaris), other Poa species of grasses, Bermuda grass, Rye grass, and any combination thereof.

Statement 95: The method according to Statement 86 or Statement 87, wherein the turfgrass is a cool season turfgrass selected from the group consisting of bluegrasses (Poa spp.), Kentucky bluegrass (Poa pratensis L.), rough bluegrass (Poa trivialis L.), Canada bluegrass (Poa compressa L.), annual bluegrass (Poa annua L.), upland bluegrass (Poa glaucantha Gaudin), wood bluegrass (Poa nemoralis L.), bulbous bluegrass (Poa bulbosa L.), bentgrasses and redtop (Agrostis spp.), creeping bentgrass (Agrostis palustris Huds.), colonial bentgrass (Agrostis tenuis Sibth.), velvet bentgrass (Agrostis canina L.), South German Mixed Bentgrass (Agrostis spp. including Agrostis tenius Sibth., Agrostis canina L., Agrostis palustris Huds.), redtop (Agrostis alba L.), fescues (Festucu spp.), red fescue (Festuca rubra L. spp. rubra), creeping fescue (Festuca rubra L.), chewings fescue (Festuca rubra commutata Gaud.), sheep fescue (Festuca ovina L.), hard fescue (Festuca longifolia Thuill.), hair fescue (Festucu capillata Lam.), tall fescue (Festuca arundinacea Schreb.), meadow fescue (Festuca elanor L.), ryegrasses (Lolium spp.), annual ryegrass (Lolium multiflorum Lam.), perennial ryegrass (Lolium perenne L.), italian ryegrass (Lolium multiflorum Lam.), wheatgrasses (Agropyron spp.), fairway wheatgrass (Agropyron cristatum (L.) crested Gaertn.), wheatgrass (Agropyron desertorum (Fisch.) Schult.), western wheatgrass (Agropyron smithii Rydb.), beachgrass (Ammophila breviligulata Fern.), smooth bromegrass (Bromus inermis Leyss.), cattails, Timothy (Phleum pratense L.), sand cattail (Phleum subulatum L.), orchardgrass (Dactylis glomerata L.), weeping alkaligrass (Puccinellia distans (L.) Parl.) crested dog's-tail (Cynosurus cristatus L.), and any combination thereof.

Statement 96: The method according to Statement 86 or Statement 87, wherein the turfgrass is a war season turfgrass selected from the group consisting of Bermudagrass (Cynodon spp. L. C. Rich), zoysiagrass (Zoysia spp. Willd.), St. Augustine grass (Stenotaphrum secundatum Walt Kuntze), centipedegrass (Eremochloa ophiuroides Munro Hack.), carpetgrass (Axonopus affinis Chase), Bahia grass (Paspalum notatum Flugge), Kikuyugrass (Pennisetum clandestinum Hochst. ex Chiov.), buffalo grass (Buchloe dactyloids (Nutt.) Engelm.), Blue gramma (Bouteloua gracilis (H.B.K.) Lag. ex Griffiths), seashore paspalum (Paspalum vaginatum Swartz), sideoats grama (Bouteloua curtipendula (Michx. Torr.), and any combination thereof.

Statement 97: The method according to any one of Statements 85-96, wherein the ornamental plants are any plants that are commonly grown for ornamental or landscaping purposes.

Statement 98: The method according to any one of Statements 85-96, wherein the ornamental plants are non-crop plants that may be grown or cultivated in a plant nursery or commercial growing environment.

Statement 99: The method according to any one of Statements 85-96, wherein the ornamental plants are potted ornamental plants.

Statement 100: The method according to any one of Statements 85-96, wherein the ornamental plants are plants grown in a container.

Statement 101: The method according to any one of Statements 85-96, wherein the ornamental plants are plants grown in the ground.

Statement 102: The method according to any one of Statements 85-96, wherein the ornamental plants are selected from the group consisting of herbaceous plants, annual shrubs, perennial shrubs, woody plants such as shrubs and trees, and any combination thereof.

Statement 103: The method according to any one of Statements 85-96, wherein the ornamental plants are selected from the group consisting of Aglaonema, Aphelandra, Azalea, Bougainvillea, Boxwood, Cattelya skinneri, Cissus, Dieffenbachia, Hibiscus, Juniper, Leather-lead Fern, Pittosporum, Philodendron, Pothos, Rhododendron, Spathiphyllum, Taxus media, Japanese Holly, Monterey Pine, Pieris, Schefflera, Begonia, Pansy, Vinca, Marigold, Zinnia, Petunia, Geranium, Impatiens, Douglas Firs, Spruce, Pines, Ornamental Pear, Pyracantha, Hawthorn, English Ivy, Anthurium, Syngonium, Ficus, and any combination thereof.

Statement 104: The method according to any one of Statements 85-103, wherein applying the composition according to any one of Statements 1 to 12 to the turf or ornamental plants comprises applying the composition at an application rate of from 1 kilogram (kg) active ingredient (a.i.) per hectare (ha) to 20 kg a.i./ha per each application, where the active ingredient is fosetyl-aluminum, fosetyl-sodium, or any agrochemically-acceptable salt thereof.

Statement 105: The method according to Statement 104, wherein the application rate is from 1 kg to 15 kg a.i./ha per each application.

Statement 106: The method according to Statement 104, wherein the application rate is from 3 kg to 13 kg a.i./ha per each application.

Statement 107: The method according to Statement 104, wherein the application rate is from 3.5 kg to 12 kg a.i./ha per each application.

Statement 108: The method according to Statement 104, wherein the application rate is from 3.5 kg to 11 kg a.i./ha per each application.

Statement 109: The method according to Statement 104, wherein the application rate is from 3.6 kg to 11.0 kg a.i./ha per each application.

Statement 110: The method according to any one of Statements 85-109, further comprising applying the composition according to any one of Statements 1 to 42 to the turf such that the turf receives from eight (8) to twelve (12) applications per year.

1. A liquid non-aqueous composition comprising
a) fosetyl-aluminium and/or fosetyl-sodium,
b) a water soluble solvent,
c) a surfactant, and
d) an organic or inorganic colorant,
wherein the fosetyl-aluminium and/or fosetyl-sodium is present in an amount of 35 to 55 wt. %, based on the total weight of the composition, and wherein the composition comprises no organic or inorganic thickener.

2. The composition of claim 1, wherein the colorant d) comprises naphthol AS-based colorants, anthraquinone-, azo-, pyrrole- and metal phthalocyanine colorants, and combinations thereof.

3. The composition of claim 1 comprising up to 15 wt. % of the organic or inorganic colorant d), based on the total weight of the composition.

4. The composition of claim 1, wherein the water soluble solvent b) comprises an alcohol or ether according to formula (I), 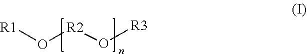
wherein
R¹ and R³ are independently of each other selected from H or (C₁-C₄)alkyl,
R² is selected from (C₂-C₄)alkyl and
n is 1 to 5.

5. The composition of claim 1, wherein the water soluble solvent b) comprises at least one of propylene carbonate, dipropylene carbonate, butylene carbonate, dibutylene carbonate, glycerine or mixtures thereof.

6. The composition of claim 1, comprising at least 20 wt. % of the water soluble solvent b), based on the total weight of the composition.

7. The composition of claim 4 comprising less than 30 wt. % of glycerine, based on the total weight of the composition.

8. The composition of claim 1 comprising less than 2 wt. % of water, based on the total weight of the composition.

9. The composition of claim 1, wherein the surfactant comprises at least one of alkali, alkaline earth and ammonium salts of:
arylsulfonates, especially dodecylbenzenesulfonates,
aryl polyethoxylated and/or polypropoxylated sulfates, especially polyethoxylated and/or polypropoxylated polyarylphenol sulfates,
naphthalenesulfonic acid or alkyl naphtalenesulfonic acid,
formaldehyde condensation products of naphthalenesulfonic acid or alkyl naphtalenesulfonic acid or
sulfonates of condensed naphtalenes or alkyl napthtalenes,
or further from
end group-capped and non-end group-capped polycondensates of ethylene oxide and/or propylene oxide with linear or branched, saturated or unsaturated alcohols,
polyoxyethylene fatty acid esters or
polycondensates of ethylene oxide and/or propylene oxide with phenols or substituted phenols.

10. The composition of claim 1, comprising up to 20 wt. % of the surfactant c), based on the total weight of the composition.

11. The composition of claim 1 wherein the fosetyl-aluminium and/or fosetyl-sodium compound is present in the composition in the form of suspended particles with a particle size distribution D90 from 10 to 40 μm.

12. The composition of claim 1, wherein the fosetyl-aluminium and/or fosetyl-sodium is present in an amount of 36 to 49 wt. %, based on the total weight of the composition.

13. The composition of claim 1, further comprising an additional active ingredient e).

14. The composition of claim 1, further comprising a formulation additive f), the formulation additive comprising at least one of an anti-foaming agent, a humectant, a stabilizers, or a pH-adjuster.

15. The composition of claim 1, further comprising a biopesticide, biostimulant, and/or a biofertilizer g).

16. A method of treating plants, the method comprising:
applying a composition of claim 1 to one or more plants or to an area for growing plants.

17. The method of claim 16, wherein the applying is done at an application rate of from about 1 kg a.i./ha to about 20 kg a.i./ha.

18. The method of claim 16, wherein the plants comprise turfgrass or ornamental plants and wherein the method comprises enhancing the quality of the plants.

19. The method of claim 16, comprising preventing or reducing fungal infestation of plants

20. The method of claim 16, comprising controlling harmful organisms to the plants, wherein the applying comprises contacting at least one of the harmful organisms, their habitat, their hosts, plants, seeds, soil, an area or environment of growing, and/or surfaces or spaces which are to be protected from attack or infestation by organisms that are harmful to plants, with an effective amount of the composition.
